(19) United States
(12) Patent Application Publication
(10) Pub. No.: US 2026/0162590 A1
(43) Pub. Date: Jun. 11, 2026

(54) PIXEL CIRCUIT, DISPLAY APPARATUS INCLUDING THE SAME AND ELECTRONIC APPARATUS INCLUDING THE SAME

(71) Applicant: Samsung Display Co., Ltd., Yongin-si (KR)

(72) Inventors: KWIHYUN KIM, Yongin-si (KR); DONGWOO KIM, Yongin-si (KR); SEHYUN LEE, Yongin-si (KR)

(21) Appl. No.: 19/179,971

(22) Filed: Apr. 15, 2025

(30) Foreign Application Priority Data
Jul. 29, 2024 (KR) 10-2024-0100500

(51) Int. Cl. G09G 3/32

(52) U.S. Cl. CPC G09G 3/32; G09G 2300/0819; G09G 2300/0842; G09G 2310/08; G09G 2320/0238; G09G 2330/021

(57) ABSTRACT

A pixel circuit includes a first transistor including a control electrode connected to a first node, a first electrode connected to a second node, and a second electrode connected to a third node, a second transistor for applying a data voltage to the first transistor, a third transistor connecting the first and third nodes, a seventh transistor including a control electrode connected to a fourth node, a first electrode connected to a fifth node, and a second electrode connected to a sixth node, an eighth transistor for applying a second data voltage to the seventh transistor, a ninth transistor connecting the fourth and sixth nodes, a twelfth transistor for applying a first initialization voltage to the fourth node in response to a second initialization signal, and a light-emitting element sequentially for emitting light based on the data voltage and the second data voltage in unit of a pixel row.

### CROSS-REFERENCE TO RELATED

The present application claims priority to, and the benefit of, Korean Patent Application No. 10-2024-0100500, filed on Jul. 29, 2024, in the Korean Intellectual Property Office, the entire disclosure of which is incorporated herein by reference.

### BACKGROUND

### 1. Field

Embodiments relate to a pixel circuit driven in a pulse width modulation method and in a progressive driving method, operating an internal compensation of a threshold voltage with fewer transistors, a display apparatus including the pixel circuit, and an electronic apparatus including the pixel circuit.

### 2. Description of the Related Art

Generally, a display apparatus includes a display panel and a display panel driver. The display panel includes a plurality of gate lines, a plurality of data lines, and a plurality of pixels. The display panel driver includes a gate driver, a data driver, and a driving controller. The gate driver outputs gate signals to the gate lines. The data driver outputs data voltages to the data lines. The driving controller controls the gate driver and the data driver.

A conventional pixel circuit driven in a pulse width modulation method, and operating internal compensation of the threshold voltage, may include nineteen or more transistors and three or more capacitors. When the pixel circuit includes nineteen or more transistors and three or more capacitors, the pixel circuit may not be applied to an ultra-high resolution display apparatus due to a limitation in integration.

### SUMMARY

Embodiments of the present disclosure provide a pixel circuit driven in a pulse width modulation method and a progressive driving method, operating an internal compensation of a threshold voltage, including fewer transistors, and thus, are applicable to a ultra-high resolution display apparatus.

Embodiments of the present disclosure also provide a display apparatus including the pixel circuit.

Embodiments of the present disclosure also provide an electronic apparatus including the pixel circuit.

In one or more embodiments of a pixel circuit according to the present disclosure, the pixel circuit includes a first transistor including a P-type transistor including a control electrode connected to a first node, a first electrode connected to a second node and a second electrode connected to a third node, a second transistor configured to apply a data voltage to the first transistor, a third transistor including an N-type transistor connected to the first node and to the third node, a seventh transistor including a P-type transistor including a control electrode connected to a fourth node, a first electrode connected to a fifth node, and a second electrode connected to a sixth node, an eighth transistor configured to apply a second data voltage to the seventh transistor, a ninth transistor including an N-type transistor connected to the fourth node and to the sixth node, a twelfth transistor including an N-type transistor configured to apply a first initialization voltage to the fourth node in response to a second initialization signal, and a light-emitting element configured to emit light based on the data voltage and the second data voltage, and configured to sequentially emit light in a unit of a pixel row.

The pixel circuit may further include a sixth transistor including a control electrode configured to receive a first initialization signal, a first electrode connected to the first node, and a second electrode configured to receive the first initialization voltage.

The pixel circuit may further include a first capacitor including a first electrode configured to receive a sweep signal and a second electrode connected to the first node.

The pixel circuit may further include a fourth transistor including a control electrode configured to receive an emission signal, a first electrode configured to receive a first power voltage, and a second electrode connected to the second node, and a fifth transistor including a control electrode configured to receive the emission signal, a first electrode connected to the third node, and a second electrode connected to the fourth node.

The pixel circuit may further include a tenth transistor including a control electrode configured to receive an emission signal, a first electrode configured to receive a second power voltage, and a second electrode connected to the fifth node, and an eleventh transistor including a control electrode configured to receive the emission signal, a first electrode connected to the sixth node, and a second electrode connected to an anode electrode of the light-emitting element.

The pixel circuit may further include a thirteenth transistor including a control electrode configured to receive an emission signal, a first electrode connected to an anode electrode of the light-emitting element, and a second electrode configured to receive a second initialization voltage.

The pixel circuit may further include a second capacitor including a first electrode configured to receive a second power voltage, and a second electrode connected to the fourth node.

The pixel circuit may further include a fourteenth transistor including a control electrode configured to receive the second initialization signal, a first electrode configured to receive a sweep signal, and a second electrode configured to receive a fourth power voltage.

The second transistor may include an N-type transistor, wherein the eighth transistor includes an N-type transistor.

A first scan signal may be configured to be applied to a control electrode of the second transistor and to a control electrode of the third transistor, wherein a second scan signal is configured to be applied to a control electrode of the eighth transistor and to a control electrode of the ninth transistor.

The second scan signal of a present pixel row may be the first scan signal of a previous pixel row.

The second transistor may include a P-type transistor, wherein the eighth transistor includes a P-type transistor.

A writing gate signal of a present pixel row may be configured to be applied to a control electrode of the second transistor and to a control electrode of the eighth transistor, wherein a compensation gate signal of the present pixel row is configured to be applied to a control electrode of the third transistor and to a control electrode of the ninth transistor.

A writing gate signal of a present pixel row may be configured to be applied to a control electrode of the second transistor, wherein a writing gate signal of a previous pixel row is configured to be applied to a control electrode of the eighth transistor, wherein a compensation gate signal of the present pixel row is configured to be applied to a control electrode of the third transistor, and wherein a compensation gate signal of the previous pixel row is configured to be applied to a control electrode of the ninth transistor.

The second transistor may include a control electrode configured to receive a first scan signal, a first electrode configured to receive the data voltage, and a second electrode connected to the second node, wherein the third transistor includes a control electrode configured to receive the first scan signal, a first electrode connected to the first node, and a second electrode connected to the third node, wherein the eighth transistor includes a control electrode configured to receive a second scan signal, a first electrode configured to receive the second data voltage, and a second electrode connected to the fifth node, wherein the ninth transistor includes a control electrode configured to receive the second scan signal, a first electrode connected to the fourth node, and a second electrode connected to the sixth node, wherein the twelfth transistor includes a control electrode configured to receive the second initialization signal, a first electrode connected to the fourth node, and a second electrode configured to receive the first initialization voltage, wherein the light-emitting element includes an anode electrode, and a cathode electrode configured to receive a third power voltage, and wherein the pixel circuit further includes a fourth transistor including a control electrode configured to receive an emission signal, a first electrode configured to receive a first power voltage, and a second electrode connected to the second node, a fifth transistor including a control electrode configured to receive the emission signal, a first electrode connected to the third node, and a second electrode connected to the fourth node, a sixth transistor including a control electrode configured to receive a first initialization signal, a first electrode connected to the first node, and a second electrode configured to receive the first initialization voltage, a tenth transistor including a control electrode configured to receive the emission signal, a first electrode configured to receive a second power voltage, and a second electrode connected to the fifth node, an eleventh transistor including a control electrode configured to receive the emission signal, a first electrode connected to the sixth node, and a second electrode connected to the anode electrode of the light-emitting element, a thirteenth transistor including a control electrode configured to receive the emission signal, a first electrode connected to the anode electrode of the light-emitting element, and a second electrode configured to receive a second initialization voltage, a first capacitor including a first electrode configured to receive a sweep signal and a second electrode connected to the first node, and a second capacitor including a first electrode configured to receive the second power voltage, and a second electrode connected to the fourth node.

The first initialization signal may have an active level in a first period, wherein the second initialization signal has an active level in the first period, wherein the first scan signal has an inactive level in the first period, wherein the second scan signal has an inactive level in the first period, wherein the emission signal has an inactive level in the first period, wherein the sweep signal has a high level in the first period, wherein the first initialization signal has an inactive level in a second period subsequent to the first period, wherein the second initialization signal has an inactive level in the second period, wherein the first scan signal has an active level in the second period, wherein the second scan signal has an active level in the second period, wherein the emission signal has the inactive level in the second period, wherein the sweep signal has the high level in the second period, wherein the first initialization signal has the inactive level in a third period subsequent to the second period, and in a fourth period subsequent to the third period, wherein the second initialization signal has the inactive level in the third period and the fourth period, wherein the first scan signal has the inactive level in the third period and the fourth period, wherein the second scan signal has the inactive level in the third period and the fourth period, wherein the emission signal has an active level in the third period and the fourth period, and wherein the sweep signal gradually decreases from the high level in the third period and the fourth period.

The first initialization signal may have the inactive level in a fifth period subsequent to the fourth period, wherein the second initialization signal has the active level in the fifth period, wherein the first scan signal has the inactive level in the fifth period, wherein the second scan signal has the inactive level in the fifth period, wherein the emission signal has the inactive level in the fifth period, and wherein the sweep signal has the high level in the fifth period.

The data voltage may be configured to be applied to the first transistor, and the light-emitting element is configured to emit light, in a writing frame, wherein the data voltage is not applied to the first transistor, and the light-emitting element is configured to emit light in a holding frame, wherein the first initialization signal has an active level in a first period of the writing frame, wherein the second initialization signal has an active level in the first period of the writing frame, wherein the first scan signal has an inactive level in the first period of the writing frame, wherein the second scan signal has an inactive level in the first period of the writing frame, wherein the first initialization signal has an inactive level in a second period of the writing frame subsequent to the first period of the writing frame, wherein the second initialization signal has an inactive level in the second period of the writing frame, wherein the first scan signal has an active level in the second period of the writing frame, wherein the second scan signal has an active level in the second period of the writing frame, wherein the first initialization signal has an inactive level in a first period of the holding frame, wherein the second initialization signal has an active level in the first period of the holding frame, wherein the first scan signal has an inactive level in the first period of the holding frame, wherein the second scan signal has an inactive level in the first period of the holding frame, wherein the first initialization signal has the inactive level in a second period of the holding frame subsequent to the first period of the holding frame, wherein the second initialization signal has an inactive level in the second period of the holding frame, wherein the first scan signal has the inactive level in the second period of the holding frame, and wherein the second scan signal has an active level in the second period of the holding frame.

In one or more embodiments of a display apparatus according to the present disclosure, the display apparatus includes a display panel including a pixel circuit, a gate driver configured to output a gate signal to the pixel circuit, and a data driver configured to output a data voltage to the pixel circuit, wherein the pixel circuit includes a first transistor including a P-type transistor including a control electrode connected to a first node, a first electrode connected to a second node, and a second electrode connected to a third node, a second transistor configured to apply the data voltage to the first transistor, a third transistor including a N-type transistor connected to the first node and to the third node, a seventh transistor including a P-type transistor including a control electrode connected to a fourth node, a first electrode connected to a fifth node, and a second electrode connected to a sixth node, an eighth transistor configured to apply a second data voltage to the seventh transistor, a ninth transistor including a N-type transistor connected to the fourth node and to the sixth node, a twelfth transistor including a N-type transistor configured to apply a first initialization voltage to the fourth node in response to a second initialization signal, and a light-emitting element configured to emit light based on the data voltage and the second data voltage, and configured to sequentially emit light in a unit of a pixel row.

In one or more embodiments of an electronic apparatus according to the present disclosure, the electronic apparatus includes a display panel including a pixel circuit, a gate driver configured to output a gate signal to the pixel circuit, a data driver configured to output a data voltage to the pixel circuit, a driving controller configured to control the gate driver and the data driver, and a processor configured to output input image data to the driving controller, wherein the pixel circuit includes a first transistor including a P-type transistor including a control electrode connected to a first node, a first electrode connected to a second node, and a second electrode connected to a third node, a second transistor configured to apply the data voltage to the first transistor, a third transistor including a N-type transistor connected to the first node and to the third node, a seventh transistor including a P-type transistor including a control electrode connected to a fourth node, a first electrode connected to a fifth node, and a second electrode connected to a sixth node, an eighth transistor configured to apply a second data voltage to the seventh transistor, a ninth transistor including a N-type transistor connected to the fourth node and to the sixth node, a twelfth transistor including a N-type transistor configured to apply a first initialization voltage to the fourth node in response to a second initialization signal, and a light-emitting element configured to emit light based on the data voltage and the second data voltage, and configured to sequentially emit light in a unit of a pixel row.

According to the pixel circuit, the display apparatus including the pixel circuit, and the electronic apparatus including the pixel circuit, the pixel circuit may include fourteen transistors and two capacitors, or thirteen transistors and two capacitors. The pixel circuit may be driven in the pulse width modulation method and the progressive driving method, may operate the internal compensation of the threshold voltage, and may include relatively fewer transistors compared to the conventional pixel circuit, so that the high integration may be achieved. Thus, the pixel circuit may be applicable to an ultra-high resolution display apparatus.

In addition, at least one transistor in the pulse width modulation circuit and at least one transistor in the constant-current-generating circuit may be N-type transistors, so that a power consumption may be reduced.

In addition, the driving transistor of the pulse width modulation circuit and the driving transistor of the constant-current-generating circuit may be P-type transistors so that a mobility may be enhanced.

In addition, the second initialization voltage applied to the second electrode of the thirteenth transistor is less than the third power voltage applied to the cathode electrode of the light-emitting element so that a black characteristic of the pixel circuit may be enhanced.

### BRIEF DESCRIPTION OF THE DRAWINGS

The above and other aspects of the present disclosure will become more apparent by describing in detailed embodiments thereof with reference to the accompanying drawings, in which:

FIG. 1 is a block diagram illustrating a display apparatus according to one or more embodiments of the present disclosure;

FIG. 2 is a circuit diagram illustrating a pixel circuit of the display panel of FIG. 1;

FIG. 3 is a circuit diagram illustrating an operation of the pixel circuit of FIG. 2 in a first period of a driving timing;

FIG. 4 is a timing diagram illustrating an example of input signals applied to the pixel circuit of FIG. 2 and node signals of the pixel circuit of FIG. 2 in the first period;

FIG. 5 is a circuit diagram illustrating an operation of the pixel circuit of FIG. 2 in a second period of the driving timing;

FIG. 6 is a timing diagram illustrating an example of input signals applied to the pixel circuit of FIG. 2 and node signals of the pixel circuit of FIG. 2 in the second period;

FIG. 7 is a circuit diagram illustrating an operation of the pixel circuit of FIG. 2 in a third period of the driving timing;

FIG. 8 is a timing diagram illustrating an example of input signals applied to the pixel circuit of FIG. 2 and node signals of the pixel circuit of FIG. 2 in the third period;

FIG. 9 is a circuit diagram illustrating an operation of the pixel circuit of FIG. 2 in a fourth period of the driving timing;

FIG. 10 is a timing diagram illustrating an example of input signals applied to the pixel circuit of FIG. 2 and node signals of the pixel circuit of FIG. 2 in the fourth period;

FIG. 11 is a circuit diagram illustrating an operation of the pixel circuit of FIG. 2 in a fifth period of the driving timing;

FIG. 12 is a timing diagram illustrating an example of input signals applied to the pixel circuit of FIG. 2 and node signals of the pixel circuit of FIG. 2 in the fifth period;

FIG. 13 is a diagram illustrating a driving frequency of the display panel of FIG. 1;

FIG. 14A is a timing diagram illustrating an example of input signals applied to the pixel circuit of FIG. 2 and node signals of the pixel circuit of FIG. 2 in a writing frame;

FIG. 14B is a timing diagram illustrating an example of input signals applied to the pixel circuit of FIG. 2 and node signals of the pixel circuit of FIG. 2 in a holding frame;

FIG. 15 is a timing diagram illustrating an example of input signals applied to the pixel circuit of FIG. 2 and node signals of the pixel circuit of FIG. 2;

FIG. 16 is a circuit diagram illustrating a pixel circuit of a display panel of a display apparatus according to one or more embodiments of the present disclosure;

FIG. 17 is a circuit diagram illustrating a pixel circuit of a display panel of a display apparatus according to one or more embodiments of the present disclosure;

FIG. 18 is a circuit diagram illustrating a pixel circuit of a display panel of a display apparatus according to one or more embodiments of the present disclosure;

FIG. 19 is a circuit diagram illustrating a pixel circuit of a display panel of a display apparatus according to one or more embodiments of the present disclosure;

FIG. 20 is a block diagram illustrating an electronic apparatus according to one or more embodiments of the present disclosure;

FIG. 21 is a diagram illustrating an example in which the electronic apparatus of FIG. 20 is implemented as a smart phone; and

FIG. 22 is a diagram illustrating an example in which the electronic apparatus of FIG. 20 is implemented as a smart watch.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

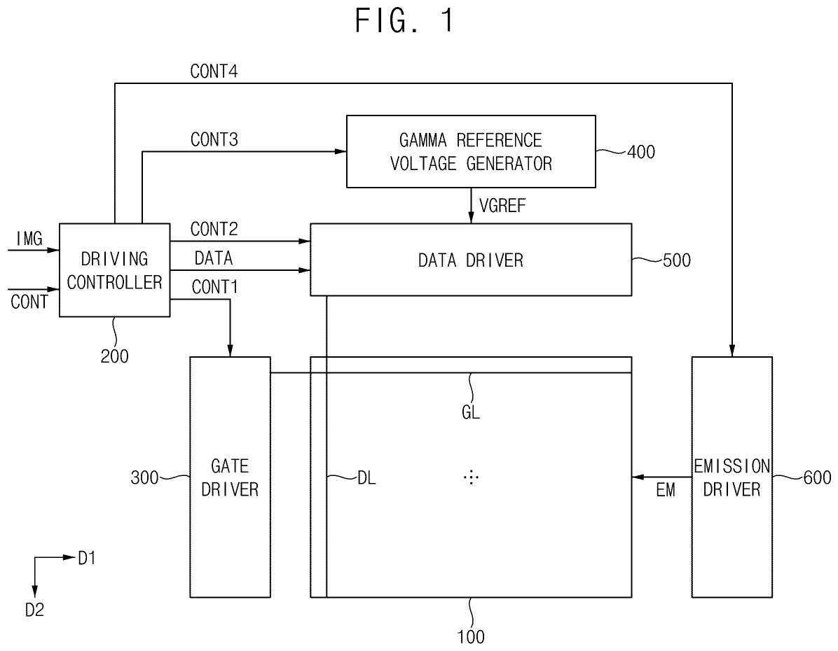

FIG. 1 is a block diagram illustrating a display apparatus according to one or more embodiments of the present disclosure.

Referring to FIG. 1, the display apparatus includes a display panel 100 and a display panel driver. The display panel driver includes a driving controller 200, a gate driver 300, a gamma reference voltage generator 400, and a data driver 500. The display panel driver may further include an emission driver 600.

The display panel 100 has a display region on which an image is displayed and a peripheral region adjacent to the display region.

The display panel 100 includes a plurality of gate lines GL, a plurality of data lines DL and a plurality of pixels electrically connected to the gate lines GL and the data lines DL. The gate lines GL may extend in a first direction D1 and the data lines DL may extend in a second direction D2 crossing the first direction D1.

The driving controller 200 receives input image data IMG and an input control signal CONT from an external apparatus. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4, and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals driving the gate lines GL in response to the first control signal CONT1 received from the driving controller 200. The gate driver 300 may output the gate signals to the gate lines GL.

In one or more embodiments of the present disclosure, the gate driver 300 may be integrated on the peripheral region of the display panel 100. In one or more embodiments of the present disclosure, the gate driver 300 may be mounted on the peripheral region of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In one or more embodiments, the gamma reference voltage generator 400 may be located in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

In one or more embodiments of the present disclosure, the data driver 500 may be integrated on the peripheral region of the display panel 100. In one or more embodiments of the present disclosure, the data driver 500 may be mounted on the peripheral region of the display panel 100.

The emission driver 600 generates emission signals EM in response to the fourth control signal CONT4 received from the driving controller 200. The emission driver 600 may output the emission signals EM to the display panel 100.

In one or more embodiments of the present disclosure, the emission driver 600 may be integrated on the peripheral region of the display panel 100. In one or more embodiments of the present disclosure, the emission driver 600 may be mounted on the peripheral region of the display panel 100.

Although the gate driver 300 is located at a first side of the display panel 100 and the emission driver 600 is located at a second side of the display panel 100 opposite to the first side in FIG. 1 for convenience of explanation, the present disclosure may not be limited thereto. For example, both of the gate driver 300 and the emission driver 600 may be located at the first side of the display panel 100. For example, the gate driver 300 and the emission driver 600 may be integrally formed. For example, both of the gate driver 300 and the emission driver 600 may be located at both sides of the display panel 100.

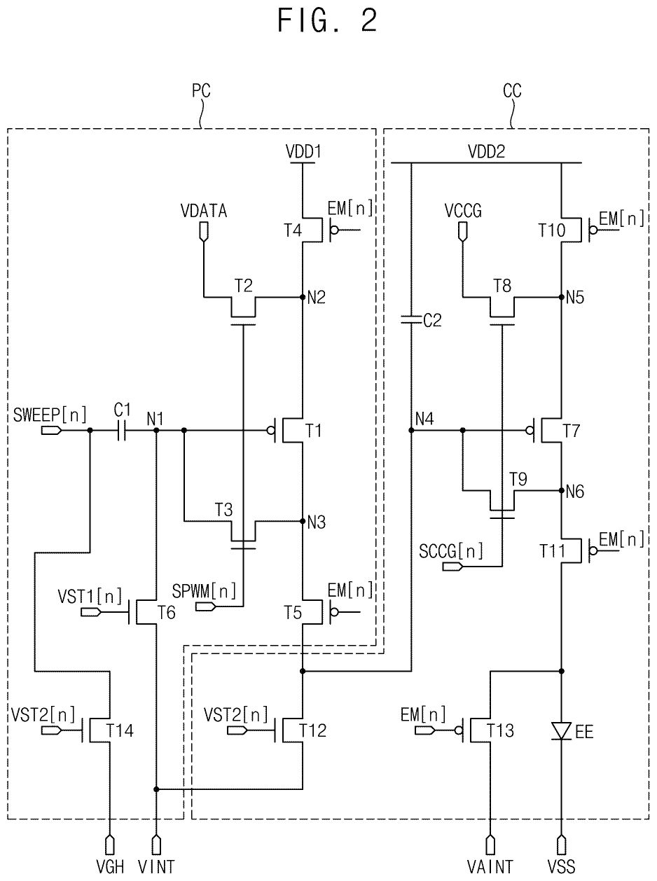

FIG. 2 is a circuit diagram illustrating a pixel circuit of the display panel 100 of FIG. 1.

Referring to FIGS. 1 and 2, the pixel circuit may include a first circuit PC and a second circuit.

The first circuit PC may be a pulse width modulation circuit for a pulse width modulation (PWM). The second circuit CC may be a constant-current-generating circuit for a constant current generation (CCG).

The first circuit PC may include first to sixth transistors T1, T2, T3, T4, T5 and T6, a fourteenth transistor T14 and a first capacitor C1. The second circuit CC may include seventh to thirteenth transistors T7, T8, T9, T10, T11, T12, and T13 and a second capacitor C2. The second circuit CC may include a light-emitting element EE.

For example, the light-emitting element EE may be a light-emitting diode. In one or more embodiments, the light-emitting element EE may be a micro light-emitting diode.

The pixel circuit includes the first transistor T1, the second transistor T2, the third transistor T3, the seventh transistor T7, the eighth transistor T8, the ninth transistor T9, the twelfth transistor T12, and the light-emitting element EE. The first transistor T1 includes a control electrode connected to a first node N1, a first electrode connected to a second node N2, and a second electrode connected to a third node N3. The second transistor T2 applies a data voltage VDATA to the first transistor T1. The third transistor T3 is connected to the first node N1 and the third node N3. The seventh transistor T7 includes a control electrode connected to a fourth node N4, a first electrode connected to a fifth node N5, and a second electrode connected to a sixth node N6. The eighth transistor T8 applies a second data voltage VCCG to the seventh transistor T7. The ninth transistor T9 is connected to the fourth node N4 and the sixth node N6. The twelfth transistor T12 applies a first initialization voltage VINT to the fourth node N4 in response to a second initialization signal VST2[n]. The light-emitting element EE emits a light based on the data voltage VDATA and the second data voltage VCCG.

The first transistor T1 may be a P-type transistor. The third transistor T3 may be an N-type transistor. The seventh transistor T7 may be a P-type transistor. The ninth transistor T9 may be an N-type transistor. The twelfth transistor T12 may be an N-type transistor.

The second transistor T2 may be an N-type transistor. The eighth transistor T8 may be an N-type transistor. A first scan signal SPWM[n] may be applied to a control electrode of the second transistor T2 and a control electrode of the third transistor T3. A second scan signal SCCG[n] may be applied to a control electrode of the eighth transistor T8 and a control electrode of the ninth transistor T9. In one or more embodiments, the second scan signal SCCG[n] may be the same signal as the first scan signal SPWM[n].

The light-emitting element EE sequentially emits a light in a unit of a pixel row.

The second transistor T2 may include the control electrode for receiving the first scan signal SPWM[n], a first electrode for receiving the data voltage VDATA, and a second electrode connected to the second node N2.

The third transistor T3 may include the control electrode for receiving the first scan signal SPWM[n], a first electrode connected to the first node N1, and a second electrode connected to the third node N3.

The eighth transistor T8 may include the control electrode for receiving the second scan signal SCCG[n], a first electrode for receiving the second data voltage VCCG, and a second electrode connected to the fifth node N5.

The ninth transistor T9 may include the control electrode for receiving the second scan signal SCCG[n], a first electrode connected to the fourth node N4, and a second electrode connected to the sixth node N6.

The twelfth transistor T12 may include the control electrode for receiving the second initialization signal VST2[n], a first electrode connected to the fourth node N4, and a second electrode for receiving the first initialization voltage VINT.

The light-emitting element EE may include an anode electrode and a cathode electrode. The cathode electrode may receive a third power voltage VSS.

The pixel circuit may further include the fourth transistor T4 including a control electrode for receiving the emission signal EM, a first electrode for receiving a first power voltage VDD1, and a second electrode connected to the second node N2, and also may include the fifth transistor T5 including a control electrode for receiving the emission signal EM, a first electrode connected to the third node N3, and a second electrode connected to the fourth node N4.

The pixel circuit may further include the sixth transistor T6 including a control electrode for receiving a first initialization signal VST1[n], a first electrode connected to the first node N1, and a second electrode for receiving the first initialization voltage VINT.

The pixel circuit may further include the tenth transistor T10 including a control electrode for receiving the emission signal EM[n], a first electrode for receiving a second power voltage VDD2, and a second electrode connected to the fifth node N5, and also may include the eleventh transistor T11 including a control electrode for receiving the emission signal EM[n], a first electrode connected to the sixth node N6, and a second electrode connected to the anode electrode of the light-emitting element EE.

The pixel circuit may further include the thirteenth transistor T13 including a control electrode for receiving the emission signal EM[n], a first electrode connected to the anode electrode of the light-emitting element EE, and a second electrode for receiving a second initialization voltage VAINT.

The pixel circuit may further include the first capacitor C1 including a first electrode for receiving a sweep signal SWEEP[n], and a second electrode connected to the first node N1, and also may include the second capacitor C2 including a first electrode for receiving the second power voltage VDD2, and a second electrode connected to the fourth node N4.

The pixel circuit may further include the fourteenth transistor T14 including a control electrode for receiving the second initialization signal VST2[n], a first electrode for receiving the sweep signal SWEEP[n], and a second electrode for receiving a fourth power voltage VGH.

As explained above, the pixel circuit may include fourteen transistors and two capacitors.

For example, the sixth transistor T6 and the fourteenth transistor T14 may be N-type transistors. The fourth transistor T4, the fifth transistor T5, the tenth transistor T10, the eleventh transistor T11, and the thirteenth transistor T13 may be P-type transistors.

Some of the transistors in the pixel circuit may be P-type transistors and some of the transistors in the pixel circuit may be N-type transistors. For example, the P-type transistor may be a low temperature polycrystalline silicon (LTPS) transistor. For example, the N-type transistor may be an oxide semiconductor transistor. The third transistor T3, the sixth transistor T6, the ninth transistor T9, and the twelfth transistor T12 may be N-type transistors so that a current leakage at the third transistor T3, the sixth transistor T6, the ninth transistor T9, and the twelfth transistor T12 may be reduced, and accordingly the pixel circuit may be stably operated even when using a relatively low power voltage, and may support a low frequency driving method and a variable frequency driving method. Thus, the power consumption of the display apparatus may be reduced by using N-type transistors for the third transistor T3, the sixth transistor T6, the ninth transistor T9, and the twelfth transistor T12.

The data voltage VDATA may have same or different voltage levels depending on intensities of light emission of pixels. In contrast, the constant-current voltage VCCG may have the same voltage level for all pixels. Alternatively, the constant-current voltage VCCG may have a first voltage level for red pixels, a second voltage level that is different from the first voltage level for green pixels, and a third voltage level that is different from the first voltage level and the second voltage level for blue pixels.

For example, the first power voltage VDD1 and the second power voltage VDD2 may be high power voltages for determining a light emission degree of the light-emitting element EE, and the third power voltage VSS may be a low power voltage for determining the light emission degree of the light-emitting element EE. The first power voltage VDD1 and the second power voltage VDD2 may be greater than the third power voltage VSS.

In addition, the first power voltage VDD1 may be greater than the second power voltage VDD2.

When the first transistor T1 is turned off and the seventh transistor T7 is turned on in a light emission period, the light-emitting element EE may emit a light. When the first transistor T1 is turned on, and accordingly, the first power voltage VDD1 is applied to the control electrode of the seventh transistor T7 in a light emission off period, the seventh transistor T7 may be turned off, and the light-emitting element EE may stop emitting a light.

Herein, if the first power voltage VDD1 is greater than the second power voltage VDD2, the seventh transistor T7 may be maintained in a turned-off state more reliably when the first power voltage VDD1 is applied to the control electrode of the seventh transistor T7.

For example, the second initialization voltage VAINT may be less than the third power voltage VSS. When the second initialization voltage VAINT is less than the third power voltage VSS, a leakage current may be reduced or prevented from flowing through the light-emitting element EE. Thus, a black characteristic of the pixel circuit may be enhanced.

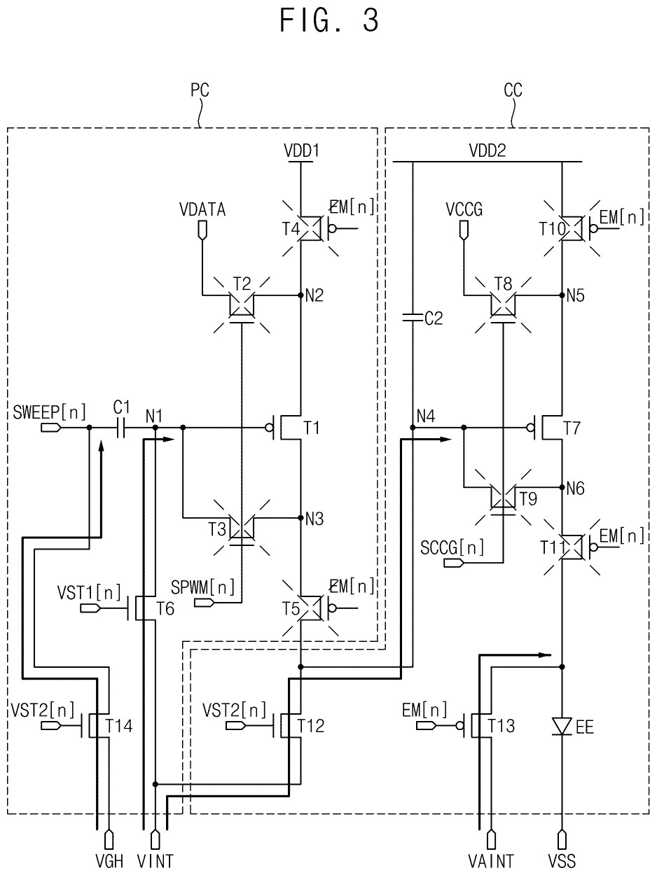

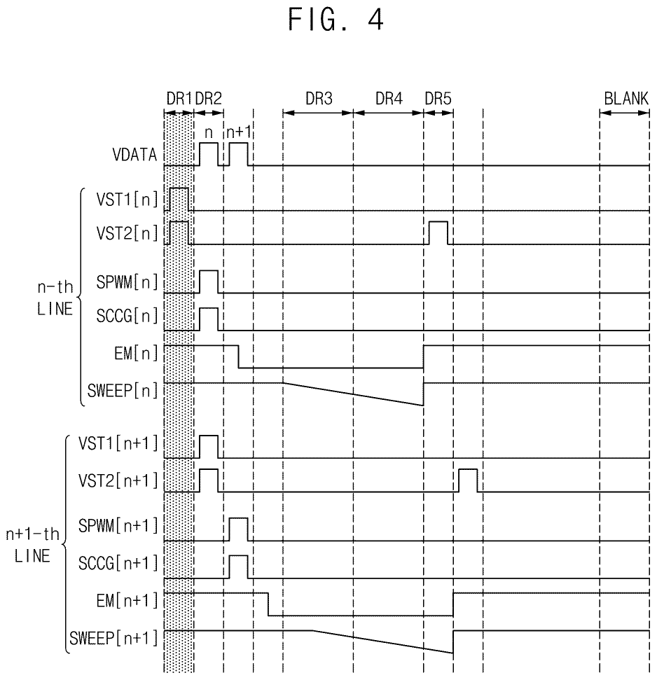

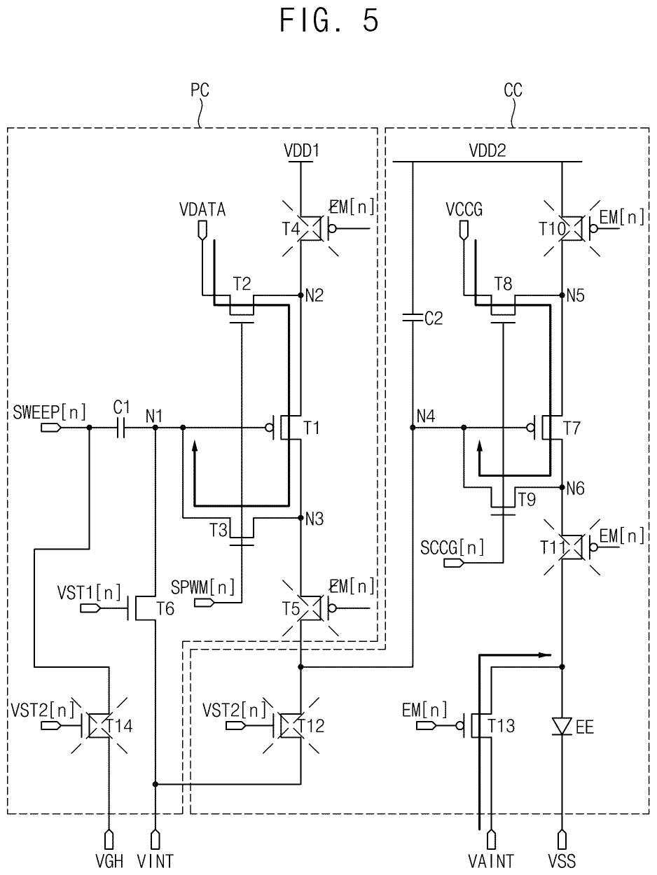

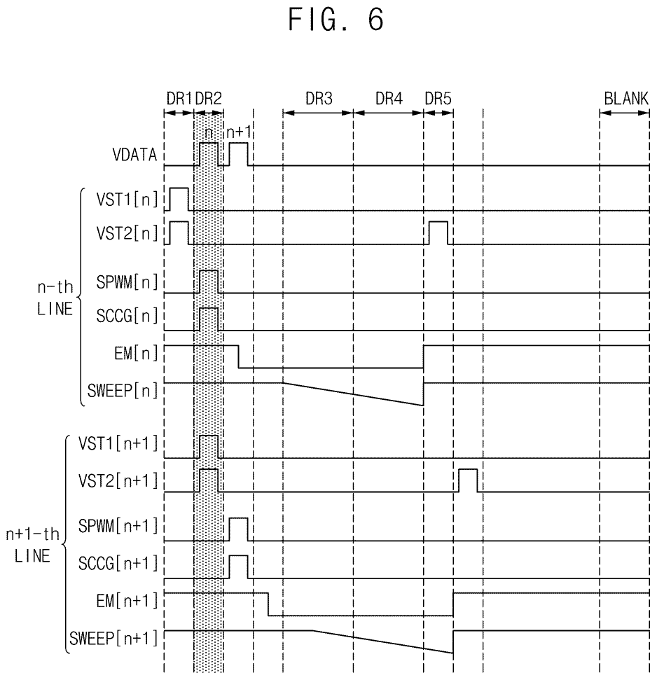

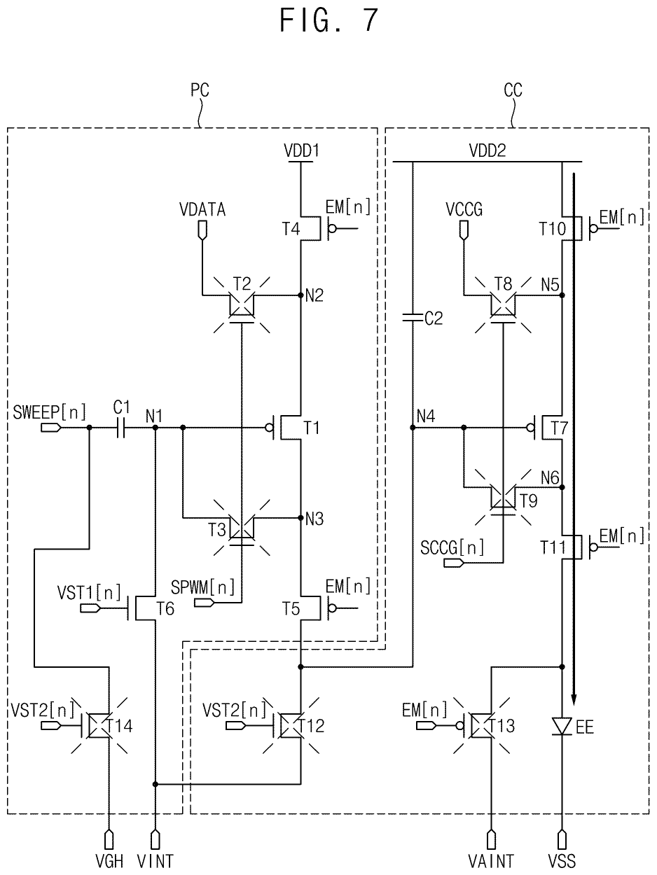

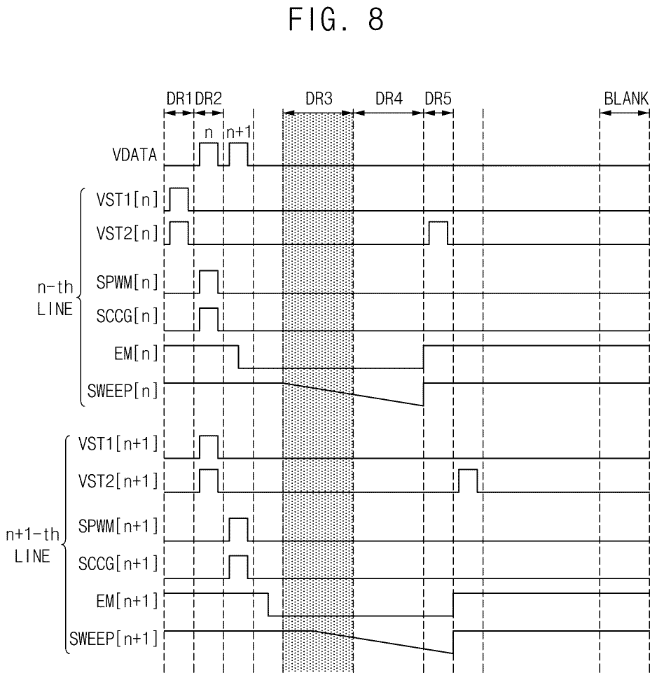

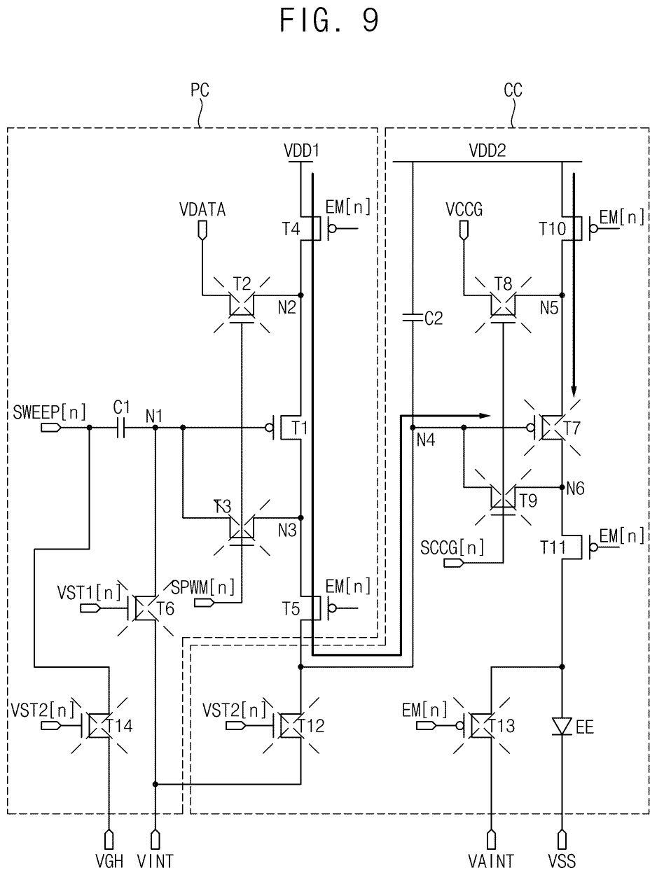

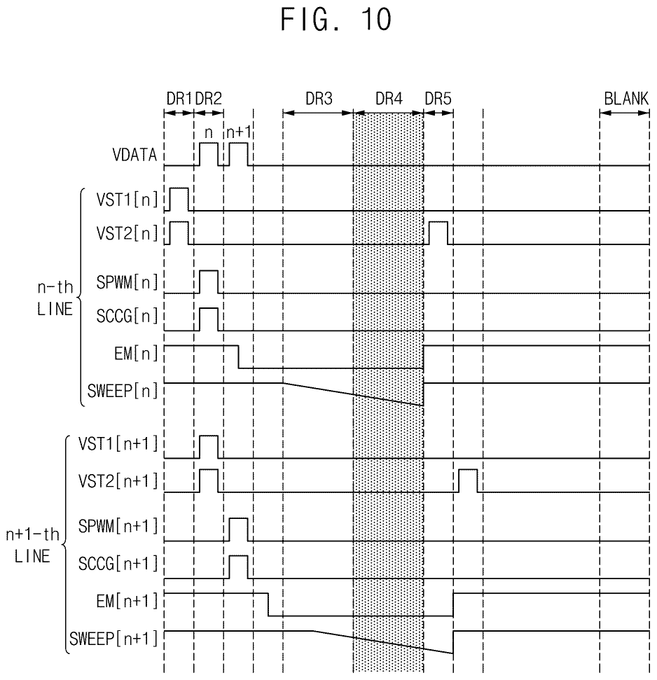

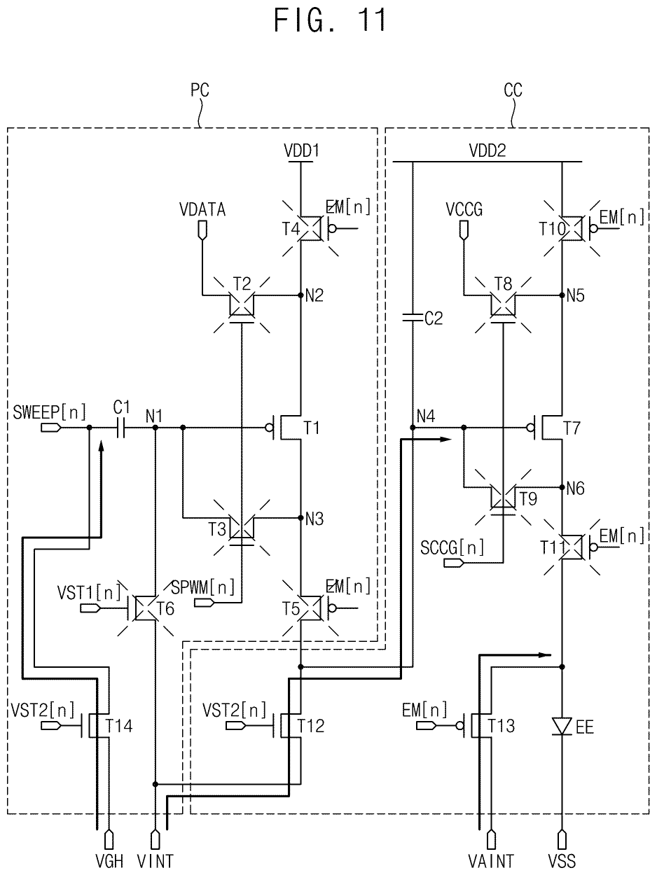

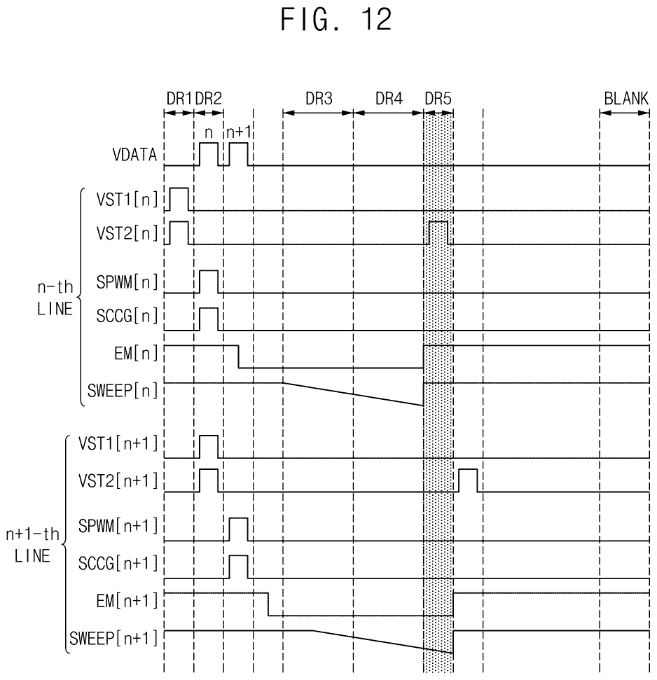

FIG. 3 is a circuit diagram illustrating an operation of the pixel circuit of FIG. 2 in a first period DR1 of a driving timing. FIG. 4 is a timing diagram illustrating an example of input signals applied to the pixel circuit of FIG. 2 and node signals of the pixel circuit of FIG. 2 in the first period DR1. FIG. 5 is a circuit diagram illustrating an operation of the pixel circuit of FIG. 2 in a second period DR2 of the driving timing. FIG. 6 is a timing diagram illustrating an example of input signals applied to the pixel circuit of FIG. 2 and node signals of the pixel circuit of FIG. 2 in the second period DR2. FIG. 7 is a circuit diagram illustrating an operation of the pixel circuit of FIG. 2 in a third period DR3 of the driving timing. FIG. 8 is a timing diagram illustrating an example of input signals applied to the pixel circuit of FIG. 2 and node signals of the pixel circuit of FIG. 2 in the third period DR3. FIG. 9 is a circuit diagram illustrating an operation of the pixel circuit of FIG. 2 in a fourth period DR4 of the driving timing. FIG. 10 is a timing diagram illustrating an example of input signals applied to the pixel circuit of FIG. 2 and node signals of the pixel circuit of FIG. 2 in the fourth period DR4. FIG. 11 is a circuit diagram illustrating an operation of the pixel circuit of FIG. 2 in a fifth period DR5 of the driving timing FIG. 12 is a timing diagram illustrating an example of input signals applied to the pixel circuit of FIG. 2 and node signals of the pixel circuit of FIG. 2 in the fifth period DR5.

Referring to FIGS. 1 to 12, the first initialization signal VST1[n], the second initialization signal VST2[n], the first scan signal SPWM[n], the second scan signal SCCG[n], the emission signal EM[n], and the sweep signal SWEEP[n] may be progressive scan signals having different timings for pixel rows. Herein, [n] may represent an n-th pixel row (“n-th line” in FIG. 4). In addition, the first initialization signal VST1[n+1], the second initialization signal VST2[n+1], the first scan signal SPWM[n+1], the second scan signal SCCG[n+1], the emission signal EM[n+1], and the sweep signal SWEEP[n+1] may be progressive scan signals having different timings for pixel rows. Herein, [n+1] may represent an n+1-th pixel row (“n+1-th line” in FIG. 4).

The pixel circuit of FIG. 2 receiving the first initialization signal VST1[n], the second initialization signal VST2[n], the first scan signal SPWM[n], the second scan signal SCCG[n], the emission signal EM[n], and the sweep signal SWEEP[n] may be a pixel circuit included in the n-th pixel row.

The first power voltage VDD1, the second power voltage VDD2, the third power voltage VSS, the fourth power voltage VGH, the first initialization voltage VINT, the second initialization voltage VAINT, and the second data voltage VCCG may be direct-current voltages.

In the driving timing, the first period DR1 may be an initialization period, the second period DR2 may be a pulse width modulation data writing and compensation period, the third period DR3 may be the light emission period, the fourth period DR4 may be the light emission off period, and the fifth period DR5 may be a sweep node initialization period.

A width of the third period DR3, which is the light emission period, may be determined by a level of the data voltage VDATA, which is a pulse width modulation data.

The sweep signal SWEEP[n] may have a constant high level in the first period DR1 and the second period DR2, and may gradually decrease in the third period DR3 and the fourth period DR4.

Referring to FIGS. 3 and 4, in the first period DR1, the first initialization signal VST1[n] may have an active level, the second initialization signal VST2[n] may have an active level, the first scan signal SPWM[n] may have an inactive level, the second scan signal SCCG[n] may have an inactive level, the emission signal EM[n] may have an inactive level, and the sweep signal SWEEP[n] may have the high level.

Herein, when the transistor receiving the first initialization signal VST1[n], the second initialization signal VST2[n], the first scan signal SPWM[n], the second scan signal SCCG[n], and the emission signal EM[n] is a P-type transistor, the active level may be a low level and the inactive level may be a high level. In contrast, when the transistor receiving the first initialization signal VST1[n], the second initialization signal VST2[n], the first scan signal SPWM[n], the second scan signal SCCG[n], and the emission signal EM[n] is an N-type transistor, the active level may be a high level and the inactive level may be a low level.

The active level and the inactive level of the emission signal EM[n] may be defined with respect to the fourth transistor T4, the fifth transistor T5, the tenth transistor T10, and the eleventh transistor T11, which are P-type transistors. The active level of the emission signal EM[n] may be a low level and the inactive level of the emission signal EM[n] may be a high level.

The first period DR1 may be the initialization period. In the initialization period DR1, the sixth transistor T6, the twelfth transistor T12, the thirteenth transistor T13, and the fourteenth transistor T14 may be turned on.

In the initialization period DR1, the control electrode (the first node N1) of the first transistor T1 may be initialized by the first initialization voltage VINT through the sixth transistor T6. The first initialization voltage VINT may be a level to turn on the first transistor T1. In the initialization period DR1, the control electrode (the fourth node N4) of the seventh transistor T7 may be initialized by the first initialization voltage VINT through the twelfth transistor T12. The first initialization voltage VINT may be a level to turn on the seventh transistor T7. In the initialization period DR1, the anode electrode of the light-emitting element EE may be initialized by the second initialization voltage VAINT through the thirteenth transistor T13. In the initialization period DR1, a sweep node receiving the sweep signal SWEEP[n] may be initialized by the fourth power voltage VGH through the fourteenth transistor T14.

Referring to FIGS. 5 and 6, in the second period DR2 subsequent to the first period DR1, the first initialization signal VST1[n] may have an inactive level, the second initialization signal VST2[n] may have an inactive level, the first scan signal SPWM[n] may have an active level, the second scan signal SCCG[n] may have an active level, the emission signal EM[n] may have the inactive level, and the sweep signal SWEEP[n] may have the high level.

The second period DR2 may be the pulse width modulation data writing and compensation period. In the pulse width modulation data writing and compensation period DR2, the second transistor T2 may be turned on by the first scan signal SPWM[n], the first transistor T1 may be turned on by the first initialization voltage VINT in the initialization period DR1, and the third transistor T3 may be turned on by the first scan signal SPWM[n]. In the pulse width modulation data writing and compensation period DR2, the eighth transistor T8 may be turned on by the second scan signal SCCG[n], the seventh transistor T7 may be turned on by the first initialization voltage VINT applied in the initialization period DR1, and the ninth transistor T9 may be turned on by the second scan signal SCCG[n]. In the pulse width modulation data writing and compensation period DR2, a turned-on state of the thirteenth transistor T13 may be maintained.

In the pulse width modulation data writing and compensation period DR2, the data voltage VDATA may be applied to the control electrode of the first transistor T1 along a path of the second transistor T2, the first transistor T1, and the third transistor T3. By a diode-connection of the third transistor T3, a threshold voltage of the first transistor T1 may be compensated in the data voltage VDATA.

In the pulse width modulation data writing and compensation period DR2, the second data voltage VCCG may be applied to the control electrode of the seventh transistor T7 along a path of the eighth transistor T8, the seventh transistor T7, and the ninth transistor T9. By a diode-connection of the ninth transistor T9, a threshold voltage of the seventh transistor T7 may be compensated in the second data voltage VCCG.

In the pulse width modulation data writing and compensation period DR2, when the data voltage VDATA is completely charged in the control electrode of the first transistor T1, the first transistor T1 may be turned off. In the pulse width modulation data writing and compensation period DR2, when the second data voltage VCCG is completely charged in the control electrode of the seventh transistor T7, the seventh transistor T7 may be turned off.

Referring to FIGS. 7 and 8, in the third period DR3 subsequent to the second period DR2, the first initialization signal VST1[n] may have the inactive level, the second initialization signal VST2[n] may have the inactive level, the first scan signal SPWM[n] may have the inactive level, the second scan signal SCCG[n] may have the inactive level, the emission signal EM[n] may have an active level, the sweep signal SWEEP[n] may gradually decrease from the high level.

The third period DR3 may be the light emission period. In the light emission period DR3, the fourth transistor T4, the fifth transistor T5, the tenth transistor T10, and the eleventh transistor T11 may be turned on by the emission signal EM[n], and the seventh transistor T7 may be turned on by the second power voltage VDD2, which is applied to the first electrode of the seventh transistor T7.

In the light emission period DR3, a current may flow along a path of the tenth transistor T10, the seventh transistor T7, the eleventh transistor T11, and the light-emitting element EE so that the light-emitting element EE may emit a light.

Referring to FIGS. 9 and 10, in the fourth period DR4 subsequent to the third period DR3, the first initialization signal VST1[n] may have the inactive level, the second initialization signal VST2[n] may have the inactive level, the first scan signal SPWM[n] may have the inactive level, the second scan signal SCCG[n] may have the inactive level, the emission signal EM[n] may have the active level, and the sweep signal SWEEP may gradually decrease following the third period DR3.

The fourth period DR4 may be the light emission off period. As the sweep signal SWEEP[n] decreases, the first transistor T1 may be turned on at a corresponding time point. The corresponding time point when the first transistor T1 is turned on may be determined by the data voltage VDATA applied to the control electrode of the first transistor T1.

When the first transistor T1 is turned on, the first power voltage VDD1 is applied to the control electrode of the seventh transistor T7 along a path of the fourth transistor T4, the first transistor T1, and the fifth transistor T5.

When the first power voltage VDD1 is applied to the control electrode of the seventh transistor T7, the seventh transistor T7 may be turned off, and the light-emitting element EE may stop emitting a light.

Referring to FIGS. 11 and 12, in the fifth period DR5 subsequent to the fourth period DR4, the first initialization signal VST1[n] may have the inactive level, the second initialization signal VST2[n] may have the active level, the first scan signal SPWM[n] may have the inactive level, the second scan signal SCCG[n] may have the inactive level, the emission signal EM[n] may have the inactive level, the sweep signal SWEEP may have the high level.

The fifth period DR5 may be the sweep node initialization period. In the sweep node initialization period DR5, the twelfth transistor T12, the thirteenth transistor T13, and the fourteenth transistor T14 may be turned on.

In the sweep node initialization period DR5, the control electrode (the fourth node N4) of the seventh transistor T7 may be initialized by the first initialization voltage VINT through the twelfth transistor T12. The first initialization voltage VINT may be a level to turn on the seventh transistor T7. In sweep node initialization period DR5, the anode electrode of the light-emitting element EE may be initialized by the second initialization voltage VAINT through the thirteenth transistor T13. In the sweep node initialization period DR5, the sweep node receiving the sweep signal SWEEP[n] may be initialized by the fourth power voltage VGH through the fourteenth transistor T14.

In the fifth period DR5 subsequent to the fourth period DR4, which is the light emission off period, the sweep node may be initialized to the high level rapidly so that a stability of the pixel circuit may be enhanced.

The driving timing may include a blank period BLANK after all pixel rows are sequentially scanned.

The pixel circuit may include fourteen transistors and two capacitors. The pixel circuit may be driven in the pulse width modulation method and the progressive driving method (a sequential driving method), may operate the internal compensation of the threshold voltage, and may include relatively fewer transistors compared to the conventional pixel circuit, so that the high integration may be achieved. Thus, the pixel circuit may be applicable to an ultra-high resolution display apparatus.

In addition, at least one transistor in the pulse width modulation circuit PC and at least one transistor in the constant-current-generating circuit CC may be N-type transistors, so that a power consumption may be reduced.

In addition, the driving transistor T1 of the pulse width modulation circuit PC and the driving transistor T7 of the constant-current-generating circuit CC are P-type transistors, so that a mobility may be enhanced.

In addition, the second initialization voltage VAINT applied to the second electrode of the thirteenth transistor T13 is less than the third power voltage VSS applied to the cathode electrode of the light-emitting element EE, so that a black characteristic of the pixel circuit may be enhanced.

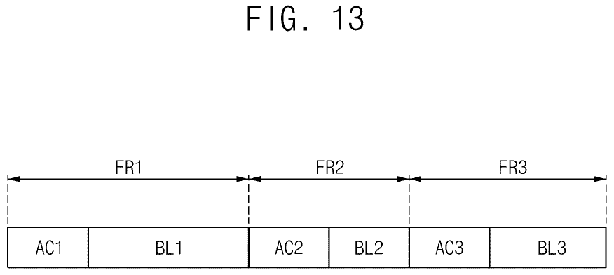

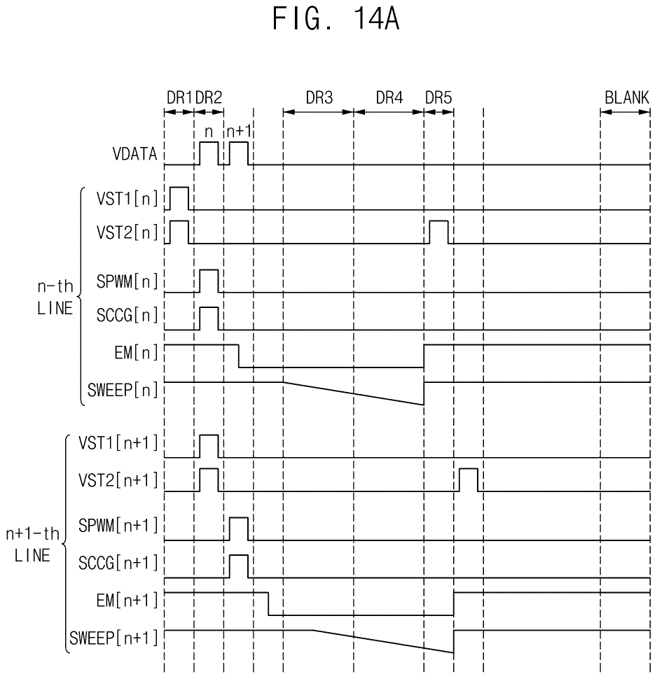

FIG. 13 is a diagram illustrating a driving frequency of the display panel 100 of FIG. 1. FIG. 14A is a timing diagram illustrating an example of input signals applied to the pixel circuit of FIG. 2 and node signals of the pixel circuit of FIG. 2 in a writing frame. FIG. 14B is a timing diagram illustrating an example of input signals applied to the pixel circuit of FIG. 2 and node signals of the pixel circuit of FIG. 2 in a holding frame.

The driving timing of the pixel circuit is substantially the same as the driving timing of the one or more embodiments explained referring to FIGS. 4, 6, 8, 10, and 12, except that the display panel is driven in variable frequencies. Thus, the same reference numerals will be used to refer to the same or like parts as those previously described, and any repetitive explanation concerning the above elements will be omitted.

Referring to FIGS. 1, 2 and 13 to 14B, the display panel 100 may be driven in the variable frequencies. A first frame FR1 having a first frequency may include a first active period AC1 and a first blank period BL1. A second frame FR2, which has a second frequency that is different from the first frequency, may include a second active period AC2 and a second blank period BL2. A third frame FR3, which has a third frequency that is different from the first frequency and the second frequency, may include a third active period AC3 and a third blank period BL3.

The first active period AC1 may have a length substantially the same as a length of the second active period AC2. The first blank period BL1 may have a length that is different from a length of the second blank period BL2.

The second active period AC2 may have the length substantially the same as a length of the third active period AC3. The second blank period BL2 may have the length that is different from a length of the third blank period BL3.

The display apparatus supporting the variable frequencies may include a writing frame in which the data voltage is written to the pixel, and a holding frame in which only light emission is operated without writing the data voltage to the pixel. The writing frame may be in the active period AC1, AC2, and AC3. The holding frame may be in the blank period BL1, BL2, and BL3.

For example, in the writing frame, the data voltage VDATA may be applied to the first transistor T1, and the light-emitting element EE may emit a light. For example, in the holding frame, the data voltage VDATA may not be applied to the first transistor T1 and the light-emitting element EE may emit a light.

In the driving timing of the writing frame of FIG. 14A, a first period DR1 may be an initialization period, a second period DR2 may be a pulse width modulation data writing and compensation period, a third period DR3 may be a light emission period, a fourth period DR4 may be a light emission off period, and a fifth period DR5 may be a sweep node initialization period. The driving timing of the writing frame of FIG. 14A may be substantially the same as the driving timings of FIGS. 4, 6, 8, 10, and 12.

In the driving timing of the holding frame of FIG. 14B, a first period DR1 may be an initialization period, a second period DR2 may be a pulse width modulation data writing and compensation period, a third period DR3 may be a light emission period, a fourth period DR4 may be a light emission off period, and a fifth period DR5 may be a sweep node initialization period.

Unlike the writing frame, the first initialization signal VST1[n] may maintain the inactive level, and the first scan signal SPWM[n] may maintain the inactive level, in the holding frame.

For example, in the first period DR1 of the writing frame, the first initialization signal VST1[n] may have an active level, the second initialization signal VST2[n] may have an active level, the first scan signal SPWM[n] may have an inactive level, and the second scan signal SCCG[n] may have an inactive level. In the second period DR2 of the writing frame subsequent to the first period DR1 of the writing frame, the first initialization signal VST1[n] may have an inactive level, the second initialization signal VST2[n] may have an inactive level, the first scan signal SPWM[n] may have an active level, and the second scan signal SCCG[n] may have an active level.

For example, in the first period DR1 of the holding frame, the first initialization signal VST1[n] may have an inactive level, the second initialization signal VST2[n] may have an active level, the first scan signal SPWM[n] may have an inactive level, and the second scan signal SCCG[n] may have an inactive level. In the second period DR2 of the holding frame subsequent to the first period DR1 of the holding frame, the first initialization signal VST1[n] may have the inactive level, the second initialization signal VST2[n] may have an inactive level, the first scan signal SPWM[n] may have the inactive level, and the second scan signal SCCG[n] may have an active level.

Timings of the signals in the third to fifth periods DR3 to DR5 of the holding frame may be substantially the same as timings of the signals in the third to fifth periods DR3 to DR5 of the writing frame.

The pixel circuit may include fourteen transistors and two capacitors. The pixel circuit may be driven in the pulse width modulation method and the progressive driving method (a sequential driving method), may operate the internal compensation of the threshold voltage and may include relatively fewer transistors compared to the conventional pixel circuit, so that the high integration may be achieved. Thus, the pixel circuit may be applicable to an ultra-high resolution display apparatus.

In addition, at least one transistor in the pulse width modulation circuit PC and at least one transistor in the constant-current-generating circuit CC may be N-type transistors so that a power consumption may be reduced.

In addition, the driving transistor T1 of the pulse width modulation circuit PC and the driving transistor T7 of the constant-current-generating circuit CC are P-type transistors so that a mobility may be enhanced.

In addition, the second initialization voltage VAINT applied to the second electrode of the thirteenth transistor T13 is less than the third power voltage VSS applied to the cathode electrode of the light-emitting element EE so that a black characteristic of the pixel circuit may be enhanced.

In addition, the pixel circuit may support a variable frequency driving method so that the power consumption of the display apparatus may be reduced.

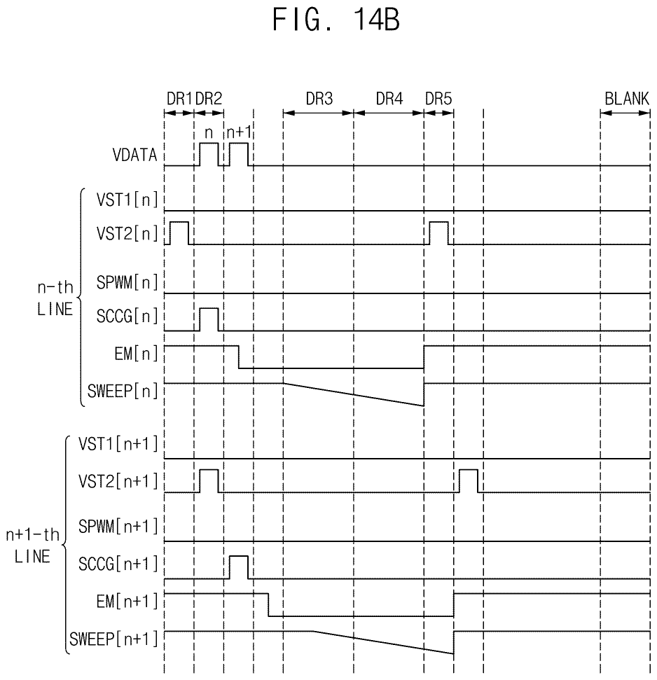

FIG. 15 is a timing diagram illustrating an example of input signals applied to the pixel circuit of FIG. 2 and node signals of the pixel circuit of FIG. 2.

The driving timing of the pixel circuit is substantially the same as the driving timing of the one or more embodiments explained referring to FIGS. 4, 6, 8, 10, and 12, except that the driving timing of the pixel circuit does not include the sweep node initialization period DR5. Thus, the same reference numerals will be used to refer to the same or like parts as those previously described, and any repetitive explanation concerning the above elements will be omitted.

Referring to FIGS. 1, 2, and 15, in the driving timing, a first period DR1 may be an initialization period, a second period DR2 may be a pulse width modulation data writing and compensation period, a third period DR3 may be a light emission period, and a fourth period DR4 may be a light emission off period.

In the first period DR1, the first initialization signal VST1[n] may have an active level, the second initialization signal VST2[n] may have an active level, the first scan signal SPWM[n] may have an inactive level, the second scan signal SCCG[n] may have an inactive level, the emission signal EM[n] may have an inactive level and the sweep signal SWEEP[n] may have the high level.

In the second period DR2 subsequent to the first period DR1, the first initialization signal VST1[n] may have an inactive level, the second initialization signal VST2[n] may have an inactive level, the first scan signal SPWM[n] may have an active level, the second scan signal SCCG[n] may have an active level, the emission signal EM[n] may have the inactive level, and the sweep signal SWEEP[n] may have the high level.

In the third period DR3 subsequent to the second period DR2, the first initialization signal VST1[n] may have the inactive level, the second initialization signal VST2[n] may have the inactive level, the first scan signal SPWM[n] may have the inactive level, the second scan signal SCCG[n] may have the inactive level, the emission signal EM[n] may have an active level, the sweep signal SWEEP[n] may gradually decrease from the high level.

In the fourth period DR4 subsequent to the third period DR3, the first initialization signal VST1[n] may have the inactive level, the second initialization signal VST2[n] may have the inactive level, the first scan signal SPWM[n] may have the inactive level, the second scan signal SCCG[n] may have the inactive level, the emission signal EM[n] may have the active level, the sweep signal SWEEP may gradually decrease following the third period DR3.

The pixel circuit may include fourteen transistors and two capacitors. The pixel circuit may be driven in the pulse width modulation method and the progressive driving method (a sequential driving method), may operate the internal compensation of the threshold voltage, and may include relatively fewer transistors compared to the conventional pixel circuit, so that the high integration may be achieved. Thus, the pixel circuit may be applicable to an ultra-high resolution display apparatus.

In addition, at least one transistor in the pulse width modulation circuit PC and at least one transistor in the constant-current-generating circuit CC may be N-type transistors so that a power consumption may be reduced.

In addition, the driving transistor T1 of the pulse width modulation circuit PC and the driving transistor T7 of the constant-current-generating circuit CC are P-type transistors so that a mobility may be enhanced.

In addition, the second initialization voltage VAINT applied to the second electrode of the thirteenth transistor T13 is less than the third power voltage VSS applied to the cathode electrode of the light-emitting element EE, so that a black characteristic of the pixel circuit may be enhanced.

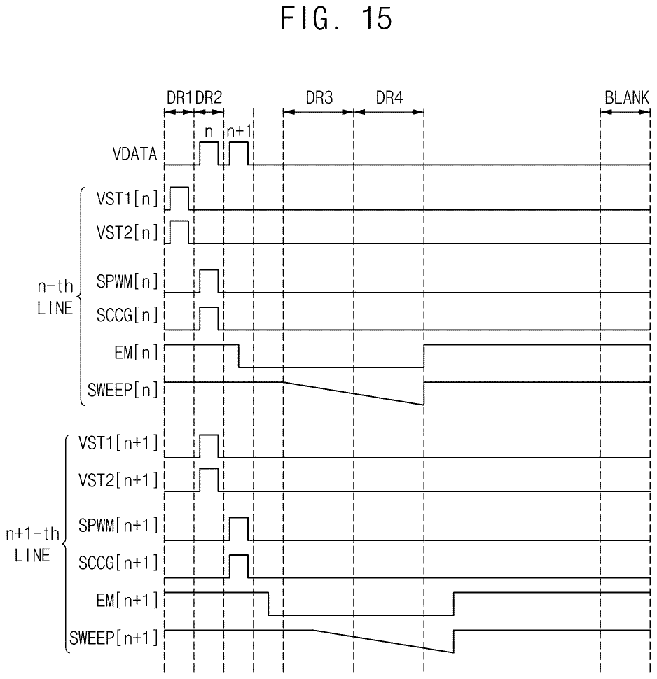

FIG. 16 is a circuit diagram illustrating a pixel circuit of a display panel of a display apparatus according to one or more embodiments of the present disclosure.

The pixel circuit is substantially the same as the pixel circuit of the one or more embodiments described referring to FIG. 2, except that the pixel circuit does not include the fourteenth transistor. Thus, the same reference numerals will be used to refer to the same or like parts as those previously described, and any repetitive explanation concerning the above elements will be omitted.

Referring to FIGS. 1, 4, 6, 8, 10, 12, and 16, the pixel circuit includes the first transistor T1, the second transistor T2, the third transistor T3, the seventh transistor T7, the eighth transistor T8, the ninth transistor T9, the twelfth transistor T12, and the light-emitting element EE. The first transistor T1 includes a control electrode connected to a first node N1, a first electrode connected to a second node N2, and a second electrode connected to a third node N3. The second transistor T2 applies a data voltage VDATA to the first transistor T1. The third transistor T3 is connected to the first node N1 and the third node N3. The seventh transistor T7 includes a control electrode connected to a fourth node N4, a first electrode connected to a fifth node N5, and a second electrode connected to a sixth node N6. The eighth transistor T8 applies a second data voltage VCCG to the seventh transistor T7. The ninth transistor T9 is connected to the fourth node N4 and the sixth node N6. The twelfth transistor T12 applies a first initialization voltage VINT to the fourth node N4 in response to a second initialization signal VST2[n]. The light-emitting element EE emits a light based on the data voltage VDATA and the second data voltage VCCG.

The pixel circuit may further include the fourth transistor T4 including a control electrode for receiving the emission signal EM, a first electrode for receiving a first power voltage VDD1, and a second electrode connected to the second node N2, and also may include the fifth transistor T5 including a control electrode for receiving the emission signal EM, a first electrode connected to the third node N3, and a second electrode connected to the fourth node N4.

The pixel circuit may further include the sixth transistor T6 including a control electrode for receiving a first initialization signal VST1[n], a first electrode connected to the first node N1, and a second electrode for receiving the first initialization voltage VINT.

The pixel circuit may further include the tenth transistor T10 including a control electrode for receiving the emission signal EM[n], a first electrode for receiving a second power voltage VDD2, and a second electrode connected to the fifth node N5, and also may include the eleventh transistor T11 including a control electrode for receiving the emission signal EM[n], a first electrode connected to the sixth node N6, and a second electrode connected to the anode electrode of the light-emitting element EE.

The pixel circuit may further include the thirteenth transistor T13 including a control electrode for receiving the emission signal EM[n], a first electrode connected to the anode electrode of the light-emitting element EE, and a second electrode for receiving a second initialization voltage VAINT.

The pixel circuit may further include the first capacitor C1 including a first electrode for receiving a sweep signal SWEEP[n], and a second electrode connected to the first node N1, and also may include the second capacitor C2 including a first electrode for receiving the second power voltage VDD2, and a second electrode connected to the fourth node N4.

The pixel circuit may include thirteen transistors and two capacitors. The pixel circuit may be driven in the pulse width modulation method and the progressive driving method (a sequential driving method), may operate the internal compensation of the threshold voltage, and may include relatively fewer transistors compared to the conventional pixel circuit, so that the high integration may be achieved. Thus, the pixel circuit may be applicable to an ultra-high resolution display apparatus.

In addition, at least one transistor in the pulse width modulation circuit PC and at least one transistor in the constant-current-generating circuit CC may be N-type transistors so that a power consumption may be reduced.

In addition, the driving transistor T1 of the pulse width modulation circuit PC and the driving transistor T7 of the constant-current-generating circuit CC are P-type transistors so that a mobility may be enhanced.

In addition, the second initialization voltage VAINT applied to the second electrode of the thirteenth transistor T13 is less than the third power voltage VSS applied to the cathode electrode of the light-emitting element EE, so that a black characteristic of the pixel circuit may be enhanced.

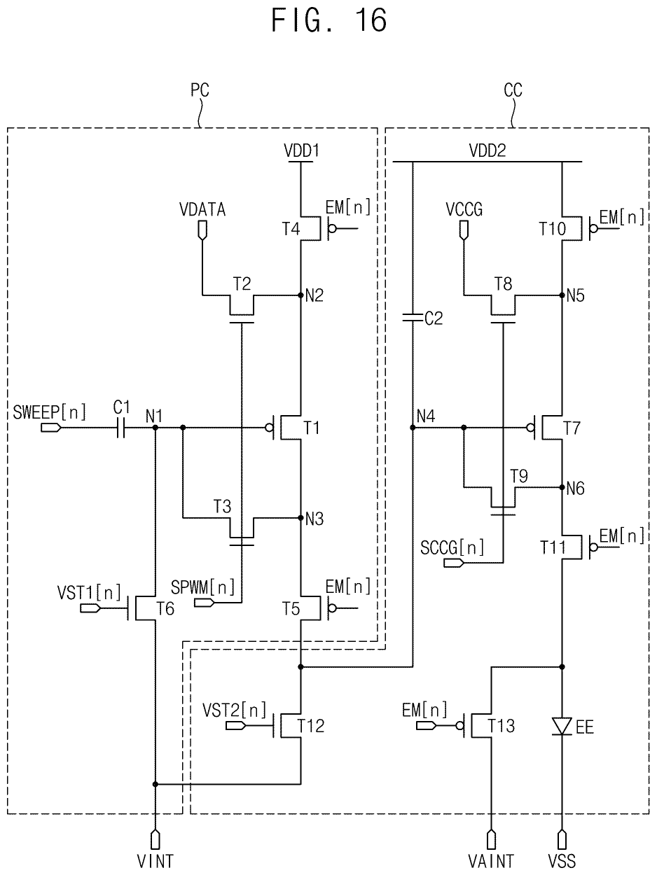

FIG. 17 is a circuit diagram illustrating a pixel circuit of a display panel of a display apparatus according to one or more embodiments of the present disclosure.

The pixel circuit is substantially the same as the pixel circuit of the one or more embodiments described referring to FIG. 2, except for a control signal applied to the eighth transistor and the ninth transistor. Thus, the same reference numerals will be used to refer to the same or like parts as those previously described, and any repetitive explanation concerning the above elements will be omitted.

Referring to FIGS. 1, 4, 6, 8, 10, 12, and 17, the pixel circuit includes the first transistor T1, the second transistor T2, the third transistor T3, the seventh transistor T7, the eighth transistor T8, the ninth transistor T9, the twelfth transistor T12, and the light-emitting element EE. The first transistor T1 includes a control electrode connected to a first node N1, a first electrode connected to a second node N2, and a second electrode connected to a third node N3. The second transistor T2 applies a data voltage VDATA to the first transistor T1. The third transistor T3 is connected to the first node N1 and the third node N3. The seventh transistor T7 includes a control electrode connected to a fourth node N4, a first electrode connected to a fifth node N5, and a second electrode connected to a sixth node N6. The eighth transistor T8 applies a second data voltage VCCG to the seventh transistor T7. The ninth transistor T9 is connected to the fourth node N4 and the sixth node N6. The twelfth transistor T12 applies a first initialization voltage VINT to the fourth node N4 in response to a second initialization signal VST2[n]. The light-emitting element EE emits a light based on the data voltage VDATA and the second data voltage VCCG.

The first transistor T1 is a P-type transistor. The third transistor T3 is an N-type transistor. The seventh transistor T7 is a P-type transistor. The ninth transistor T9 is an N-type transistor. The twelfth transistor T12 is an N-type transistor.

The second transistor T2 may be an N-type transistor. The eighth transistor T8 may be an N-type transistor. A first scan signal SPWM[n] may be applied to a control electrode of the second transistor T2 and to a control electrode of the third transistor T3. A second scan signal SCCG[n] may be applied to a control electrode of the eighth transistor T8 and to a control electrode of the ninth transistor T9.

The second scan signal SCCG[n] of a present pixel row may be the first scan signal SPWM[n-1] of a previous pixel row. A driver for generating the second scan signal SCCG[n] and a driver for generating the first scan signal SPWM[n-1] may be integrated so that a size of the gate driver 300 may be reduced, and so that a dead space of the display panel 100 may be reduced when the gate driver 300 is integrated on the display panel 100.

The light-emitting element EE sequentially emits a light in a unit of a pixel row.

The concept of one or more embodiments in which the second scan signal SCCG[n] of the present pixel row is the same as the first scan signal SPWM[n-1] of the previous pixel row may be applied to the pixel circuit of FIG. 16 as well as the pixel circuit of FIG. 2.

The pixel circuit may include fourteen transistors and two capacitors, or thirteen transistors and two capacitors. The pixel circuit may be driven in the pulse width modulation method and the progressive driving method (a sequential driving method), may operate the internal compensation of the threshold voltage, and may include relatively fewer transistors compared to the conventional pixel circuit, so that the high integration may be achieved. Thus, the pixel circuit may be applicable to an ultra-high resolution display apparatus.

In addition, at least one transistor in the pulse width modulation circuit PC and at least one transistor in the constant-current-generating circuit CC may be N-type transistors, so that a power consumption may be reduced.

In addition, the driving transistor T1 of the pulse width modulation circuit PC and the driving transistor T7 of the constant-current-generating circuit CC are P-type transistors, so that a mobility may be enhanced.

In addition, the second initialization voltage VAINT applied to the second electrode of the thirteenth transistor T13 is less than the third power voltage VSS applied to the cathode electrode of the light-emitting element EE, so that a black characteristic of the pixel circuit may be enhanced.

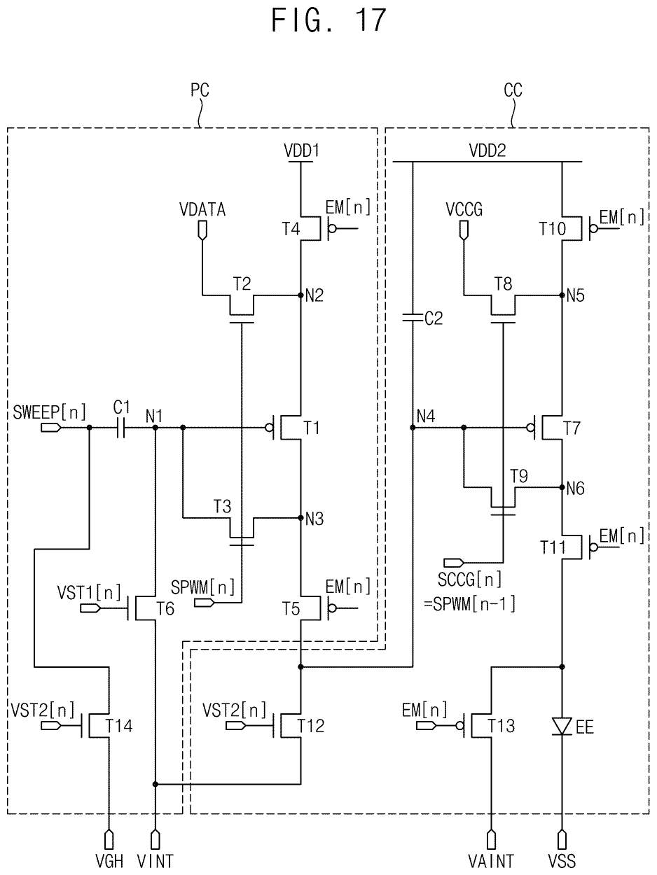

FIG. 18 is a circuit diagram illustrating a pixel circuit of a display panel of a display apparatus according to one or more embodiments of the present disclosure.

The pixel circuit is substantially the same as the pixel circuit of the one or more embodiments described referring to FIG. 2, except that the second transistor and the eighth transistor are P-type transistors, and except for control signals applied to the second transistor, the third transistor, the eighth transistor, and the ninth transistor. Thus, the same reference numerals will be used to refer to the same or like parts as those previously described, and any repetitive explanation concerning the above elements will be omitted.

Referring to FIGS. 1, 4, 6, 8, 10, 12, and 18, the pixel circuit includes the first transistor T1, the second transistor T2, the third transistor T3, the seventh transistor T7, the eighth transistor T8, the ninth transistor T9, the twelfth transistor T12, and the light-emitting element EE. The first transistor T1 includes a control electrode connected to a first node N1, a first electrode connected to a second node N2, and a second electrode connected to a third node N3. The second transistor T2 applies a data voltage VDATA to the first transistor T1. The third transistor T3 is connected to the first node N1 and to the third node N3. The seventh transistor T7 includes a control electrode connected to a fourth node N4, a first electrode connected to a fifth node N5, and a second electrode connected to a sixth node N6. The eighth transistor T8 applies a second data voltage VCCG to the seventh transistor T7. The ninth transistor T9 is connected to the fourth node N4 and the sixth node N6. The twelfth transistor T12 applies a first initialization voltage VINT to the fourth node N4 in response to a second initialization signal VST2[n]. The light-emitting element EE emits a light based on the data voltage VDATA and the second data voltage VCCG.

The first transistor T1 is a P-type transistor. The third transistor T3 is an N-type transistor. The seventh transistor T7 is a P-type transistor. The ninth transistor T9 is an N-type transistor. The twelfth transistor T12 is an N-type transistor.

The second transistor T2 may be a P-type transistor. The eighth transistor T8 may be a P-type transistor.

A writing gate signal GW[n] of a present pixel row may be applied to a control electrode of the second transistor T2 and to a control electrode of the eighth transistor T8. A compensation gate signal GC[n] of the present pixel row may be applied to a control electrode of the third transistor T3 and a control electrode of the ninth transistor T9.

The same signal may be applied to the control electrode of the second transistor T2 and the control electrode of the eighth transistor T8. A driver for generating a control signal of the second transistor T2 and a driver for generating a control signal of the eighth transistor T8 may be integrated, so that a size of the gate driver 300 may be reduced, and so that a dead space of the display panel 100 may be reduced when the gate driver 300 is integrated on the display panel 100.

The same signal may be applied to the control electrode of the third transistor T3 and the control electrode of the ninth transistor T9. A driver for generating a control signal of the third transistor T3 and a driver for generating a control signal of the ninth transistor T9 may be integrated, so that a size of the gate driver 300 may be reduced, and so that a dead space of the display panel 100 may be reduced when the gate driver 300 is integrated on the display panel 100.

The light-emitting element EE sequentially emits a light in a unit of a pixel row.

The concept of one or more embodiments in which the second transistor T2 and the eighth transistor T8 are P-type transistors may be applied to the pixel circuit of FIG. 16 as well as the pixel circuit of FIG. 2.

The pixel circuit may include fourteen transistors and two capacitors, or may include thirteen transistors and two capacitors. The pixel circuit may be driven in the pulse width modulation method and the progressive driving method (a sequential driving method), may operate the internal compensation of the threshold voltage, and may include relatively fewer transistors compared to the conventional pixel circuit, so that the high integration may be achieved. Thus, the pixel circuit may be applicable to an ultra-high resolution display apparatus.

In addition, at least one transistor in the pulse width modulation circuit PC and at least one transistor in the constant-current-generating circuit CC may be N-type transistors so that a power consumption may be reduced.

In addition, the driving transistor T1 of the pulse width modulation circuit PC and the driving transistor T7 of the constant-current-generating circuit CC are P-type transistors, so that a mobility may be enhanced.

In addition, the second initialization voltage VAINT applied to the second electrode of the thirteenth transistor T13 is less than the third power voltage VSS applied to the cathode electrode of the light-emitting element EE, so that a black characteristic of the pixel circuit may be enhanced.

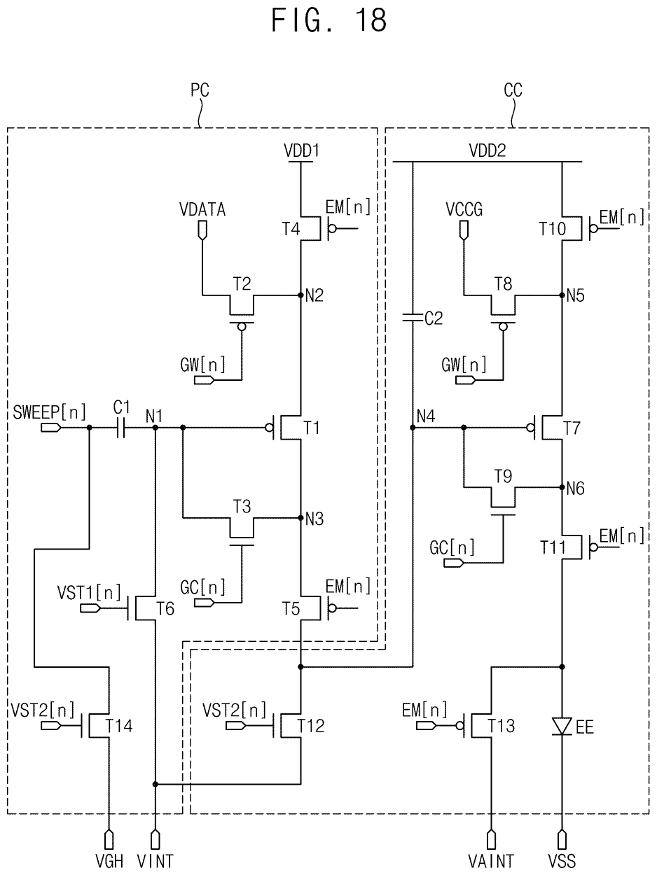

FIG. 19 is a circuit diagram illustrating a pixel circuit of a display panel of a display apparatus according to one or more embodiments of the present disclosure.

The pixel circuit is substantially the same as the pixel circuit of the one or more embodiments described referring to FIG. 2, except that the second transistor and the eighth transistor are P-type transistors, and except for control signals applied to the second transistor, the third transistor, the eighth transistor, and the ninth transistor. Thus, the same reference numerals will be used to refer to the same or like parts as those previously described, and any repetitive explanation concerning the above elements will be omitted.

Referring to FIGS. 1, 4, 6, 8, 10, 12, and 19, the pixel circuit includes the first transistor T1, the second transistor T2, the third transistor T3, the seventh transistor T7, the eighth transistor T8, the ninth transistor T9, the twelfth transistor T12, and the light-emitting element EE. The first transistor T1 includes a control electrode connected to a first node N1, a first electrode connected to a second node N2, and a second electrode connected to a third node N3. The second transistor T2 applies a data voltage VDATA to the first transistor T1. The third transistor T3 is connected to the first node N1 and the third node N3. The seventh transistor T7 includes a control electrode connected to a fourth node N4, a first electrode connected to a fifth node N5, and a second electrode connected to a sixth node N6. The eighth transistor T8 applies a second data voltage VCCG to the seventh transistor T7. The ninth transistor T9 is connected to the fourth node N4 and the sixth node N6. The twelfth transistor T12 applies a first initialization voltage VINT to the fourth node N4 in response to a second initialization signal VST2[n]. The light-emitting element EE emits a light based on the data voltage VDATA and the second data voltage VCCG.

The first transistor T1 is a P-type transistor. The third transistor T3 is an N-type transistor. The seventh transistor T7 is a P-type transistor. The ninth transistor T9 is an N-type transistor. The twelfth transistor T12 is an N-type transistor.

The second transistor T2 may be a P-type transistor. The eighth transistor T8 may be a P-type transistor.

A writing gate signal GW[n] of a present pixel row may be applied to a control electrode of the second transistor T2. A writing gate signal GW[n-1] of a previous pixel row may be applied to a control electrode of the eighth transistor T8. A compensation gate signal GC[n] of the present pixel row may be applied to a control electrode of the third transistor T3. A compensation gate signal GC[n-1] of the previous pixel row may be applied to a control electrode of the ninth transistor T9.

A driver for generating a control signal of the second transistor T2 and a driver for generating a control signal of the eighth transistor T8 may be integrated, so that a size of the gate driver 300 may be reduced, and so that a dead space of the display panel 100 may be reduced when the gate driver 300 is integrated on the display panel 100.

A driver for generating a control signal of the third transistor T3 and a driver for generating a control signal of the ninth transistor T9 may be integrated, so that a size of the gate driver 300 may be reduced, and so that a dead space of the display panel 100 may be reduced when the gate driver 300 is integrated on the display panel 100.

The light-emitting element EE sequentially emits a light in a unit of a pixel row.

The concept of one or more embodiments in which the second transistor T2 and the eighth transistor T8 are P-type transistors may be applied to the pixel circuit of FIG. 16 as well as the pixel circuit of FIG. 2.

The pixel circuit may include fourteen transistors and two capacitors, or may include thirteen transistors and two capacitors. The pixel circuit may be driven in the pulse width modulation method and the progressive driving method (a sequential driving method), may operate the internal compensation of the threshold voltage, and may include relatively fewer transistors compared to the conventional pixel circuit, so that the high integration may be achieved. Thus, the pixel circuit may be applicable to an ultra-high resolution display apparatus.

In addition, at least one transistor in the pulse width modulation circuit PC and at least one transistor in the constant-current-generating circuit CC may be N-type transistors, so that a power consumption may be reduced.

In addition, the driving transistor T1 of the pulse width modulation circuit PC and the driving transistor T7 of the constant-current-generating circuit CC are P-type transistors, so that a mobility may be enhanced.

In addition, the second initialization voltage VAINT applied to the second electrode of the thirteenth transistor T13 is less than the third power voltage VSS applied to the cathode electrode of the light-emitting element EE, so that a black characteristic of the pixel circuit may be enhanced.

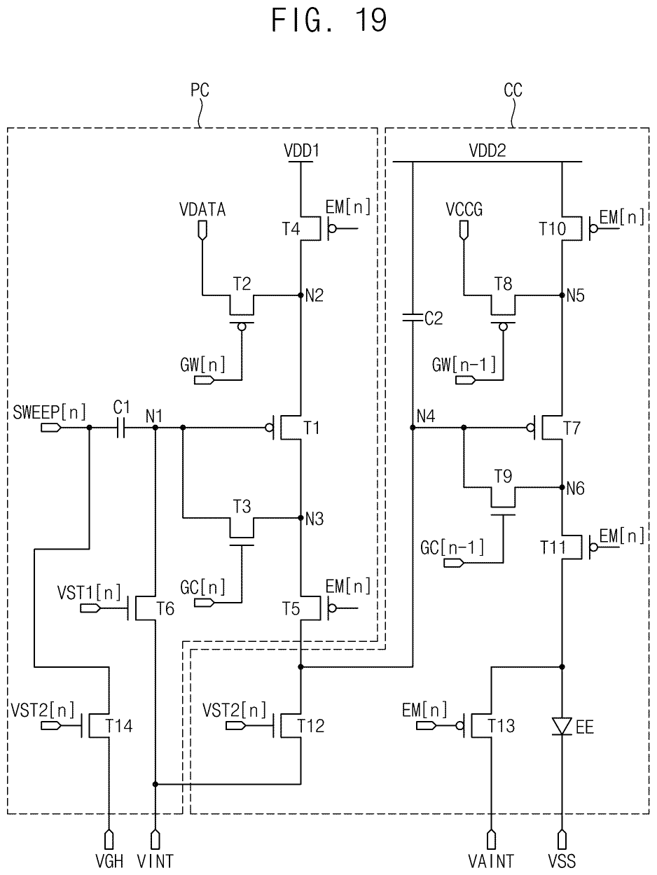

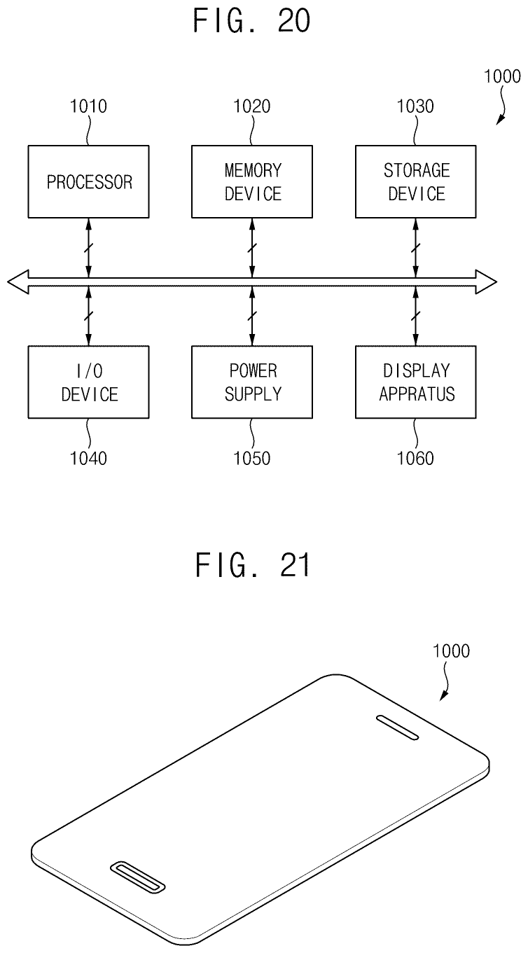

FIG. 20 is a block diagram illustrating an electronic apparatus 1000 according to one or more embodiments of the present disclosure. FIG. 21 is a diagram illustrating an example in which the electronic apparatus 1000 of FIG. 20 is implemented as a smart phone.

Referring to FIGS. 20 and 21, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In one or more embodiments, as illustrated in FIG. 21, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head-mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus, such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device, such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device, such as a keyboard, a keypad, a mouse device, a touch-pad, a touch-screen, or the like, and an output device, such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

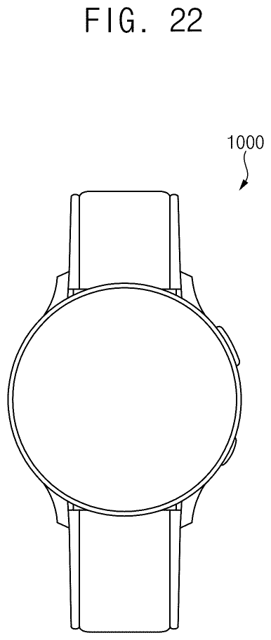

FIG. 22 is a diagram illustrating an example in which the electronic apparatus 1000 of FIG. 20 is implemented as a smart watch.

Referring to FIGS. 20 and 22, the electronic apparatus 1000 may be implemented as a smart watch. The smart watch may be an example of the electronic apparatus 1000 requiring an ultra-high resolution display panel.

According to the pixel circuit, the display apparatus and the electronic apparatus of the present disclosure as explained above, the ultra-high resolution display apparatus may be implemented using the pixel circuit having the high integration.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel aspects of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with functional equivalents of the claims to be included therein.

What is claimed is:

1. A pixel circuit comprising:
a first transistor comprising a P-type transistor comprising a control electrode connected to a first node, a first electrode connected to a second node, and a second electrode connected to a third node;
a second transistor configured to apply a data voltage to the first transistor;
a third transistor comprising an N-type transistor connected to the first node and to the third node;
a seventh transistor comprising a P-type transistor comprising a control electrode connected to a fourth node, a first electrode connected to a fifth node, and a second electrode connected to a sixth node;
an eighth transistor configured to apply a second data voltage to the seventh transistor;
a ninth transistor comprising an N-type transistor connected to the fourth node and to the sixth node;
a twelfth transistor comprising an N-type transistor configured to apply a first initialization voltage to the fourth node in response to a second initialization signal; and
a light-emitting element configured to emit light based on the data voltage and the second data voltage, and configured to sequentially emit light in a unit of a pixel row.

2. The pixel circuit of claim 1, further comprising a sixth transistor comprising a control electrode configured to receive a first initialization signal, a first electrode connected to the first node, and a second electrode configured to receive the first initialization voltage.

3. The pixel circuit of claim 1, further comprising a first capacitor comprising a first electrode configured to receive a sweep signal, and a second electrode connected to the first node.

4. The pixel circuit of claim 1, further comprising:
a fourth transistor comprising a control electrode configured to receive an emission signal, a first electrode configured to receive a first power voltage, and a second electrode connected to the second node; and
a fifth transistor comprising a control electrode configured to receive the emission signal, a first electrode connected to the third node, and a second electrode connected to the fourth node.

5. The pixel circuit of claim 1, further comprising:
a tenth transistor comprising a control electrode configured to receive an emission signal, a first electrode configured to receive a second power voltage, and a second electrode connected to the fifth node; and
an eleventh transistor comprising a control electrode configured to receive the emission signal, a first electrode connected to the sixth node, and a second electrode connected to an anode electrode of the light-emitting element.

6. The pixel circuit of claim 1, further comprising a thirteenth transistor comprising a control electrode configured to receive an emission signal, a first electrode connected to an anode electrode of the light-emitting element, and a second electrode configured to receive a second initialization voltage.

7. The pixel circuit of claim 1, further comprising a second capacitor comprising a first electrode configured to receive a second power voltage, and a second electrode connected to the fourth node.

8. The pixel circuit of claim 1, further comprising a fourteenth transistor comprising a control electrode configured to receive the second initialization signal, a first electrode configured to receive a sweep signal, and a second electrode configured to receive a fourth power voltage.

9. The pixel circuit of claim 1, wherein the second transistor comprises an N-type transistor, and
wherein the eighth transistor comprises an N-type transistor.

10. The pixel circuit of claim 9, wherein a first scan signal is configured to be applied to a control electrode of the second transistor and to a control electrode of the third transistor, and
wherein a second scan signal is configured to be applied to a control electrode of the eighth transistor and to a control electrode of the ninth transistor.

11. The pixel circuit of claim 10, wherein the second scan signal of a present pixel row is the first scan signal of a previous pixel row.

12. The pixel circuit of claim 1, wherein the second transistor comprises a P-type transistor, and
wherein the eighth transistor comprises a P-type transistor.

13. The pixel circuit of claim 12, wherein a writing gate signal of a present pixel row is configured to be applied to a control electrode of the second transistor and to a control electrode of the eighth transistor, and
wherein a compensation gate signal of the present pixel row is configured to be applied to a control electrode of the third transistor and to a control electrode of the ninth transistor.

14. The pixel circuit of claim 12, wherein a writing gate signal of a present pixel row is configured to be applied to a control electrode of the second transistor,
wherein a writing gate signal of a previous pixel row is configured to be applied to a control electrode of the eighth transistor,
wherein a compensation gate signal of the present pixel row is configured to be applied to a control electrode of the third transistor, and
wherein a compensation gate signal of the previous pixel row is configured to be applied to a control electrode of the ninth transistor.

15. The pixel circuit of claim 1, wherein the second transistor comprises a control electrode configured to receive a first scan signal, a first electrode configured to receive the data voltage, and a second electrode connected to the second node,
wherein the third transistor comprises a control electrode configured to receive the first scan signal, a first electrode connected to the first node, and a second electrode connected to the third node,
wherein the eighth transistor comprises a control electrode configured to receive a second scan signal, a first electrode configured to receive the second data voltage, and a second electrode connected to the fifth node,
wherein the ninth transistor comprises a control electrode configured to receive the second scan signal, a first electrode connected to the fourth node, and a second electrode connected to the sixth node,
wherein the twelfth transistor comprises a control electrode configured to receive the second initialization signal, a first electrode connected to the fourth node, and a second electrode configured to receive the first initialization voltage,
wherein the light-emitting element comprises an anode electrode, and a cathode electrode configured to receive a third power voltage, and
wherein the pixel circuit further comprises:
a fourth transistor comprising a control electrode configured to receive an emission signal, a first electrode configured to receive a first power voltage, and a second electrode connected to the second node;
a fifth transistor comprising a control electrode configured to receive the emission signal, a first electrode connected to the third node, and a second electrode connected to the fourth node;
a sixth transistor comprising a control electrode configured to receive a first initialization signal, a first electrode connected to the first node, and a second electrode configured to receive the first initialization voltage;
a tenth transistor comprising a control electrode configured to receive the emission signal, a first electrode configured to receive a second power voltage, and a second electrode connected to the fifth node;
an eleventh transistor comprising a control electrode configured to receive the emission signal, a first electrode connected to the sixth node, and a second electrode connected to the anode electrode of the light-emitting element;
a thirteenth transistor comprising a control electrode configured to receive the emission signal, a first electrode connected to the anode electrode of the light-emitting element, and a second electrode configured to receive a second initialization voltage;
a first capacitor comprising a first electrode configured to receive a sweep signal, and a second electrode connected to the first node; and
a second capacitor comprising a first electrode configured to receive the second power voltage, and a second electrode connected to the fourth node.

16. The pixel circuit of claim 15, wherein the first initialization signal has an active level in a first period,
wherein the second initialization signal has an active level in the first period,
wherein the first scan signal has an inactive level in the first period,
wherein the second scan signal has an inactive level in the first period,
wherein the emission signal has an inactive level in the first period,
wherein the sweep signal has a high level in the first period,
wherein the first initialization signal has an inactive level in a second period subsequent to the first period,
wherein the second initialization signal has an inactive level in the second period,
wherein the first scan signal has an active level in the second period,
wherein the second scan signal has an active level in the second period,
wherein the emission signal has the inactive level in the second period,
wherein the sweep signal has the high level in the second period,
wherein the first initialization signal has the inactive level in a third period subsequent to the second period, and in a fourth period subsequent to the third period,
wherein the second initialization signal has the inactive level in the third period and the fourth period,
wherein the first scan signal has the inactive level in the third period and the fourth period,
wherein the second scan signal has the inactive level in the third period and the fourth period,
wherein the emission signal has an active level in the third period and the fourth period, and
wherein the sweep signal gradually decreases from the high level in the third period and the fourth period.

17. The pixel circuit of claim 16, wherein the first initialization signal has the inactive level in a fifth period subsequent to the fourth period,
wherein the second initialization signal has the active level in the fifth period,
wherein the first scan signal has the inactive level in the fifth period,
wherein the second scan signal has the inactive level in the fifth period,
wherein the emission signal has the inactive level in the fifth period, and
wherein the sweep signal has the high level in the fifth period.

18. The pixel circuit of claim 15, wherein the data voltage is configured to be applied to the first transistor, and the light-emitting element is configured to emit light, in a writing frame,
wherein the data voltage is not applied to the first transistor, and the light-emitting element is configured to emit light in a holding frame,
wherein the first initialization signal has an active level in a first period of the writing frame,
wherein the second initialization signal has an active level in the first period of the writing frame,
wherein the first scan signal has an inactive level in the first period of the writing frame,
wherein the second scan signal has an inactive level in the first period of the writing frame,
wherein the first initialization signal has an inactive level in a second period of the writing frame subsequent to the first period of the writing frame,
wherein the second initialization signal has an inactive level in the second period of the writing frame,
wherein the first scan signal has an active level in the second period of the writing frame,
wherein the second scan signal has an active level in the second period of the writing frame,
wherein the first initialization signal has an inactive level in a first period of the holding frame,
wherein the second initialization signal has an active level in the first period of the holding frame,
wherein the first scan signal has an inactive level in the first period of the holding frame,
wherein the second scan signal has an inactive level in the first period of the holding frame,
wherein the first initialization signal has the inactive level in a second period of the holding frame subsequent to the first period of the holding frame,
wherein the second initialization signal has an inactive level in the second period of the holding frame,
wherein the first scan signal has the inactive level in the second period of the holding frame, and
wherein the second scan signal has an active level in the second period of the holding frame.

19. A display apparatus comprising:
a display panel comprising a pixel circuit;
a gate driver configured to output a gate signal to the pixel circuit; and
a data driver configured to output a data voltage to the pixel circuit,
wherein the pixel circuit comprises:
a first transistor comprising a P-type transistor comprising a control electrode connected to a first node, a first electrode connected to a second node, and a second electrode connected to a third node;
a second transistor configured to apply the data voltage to the first transistor;
a third transistor comprising a N-type transistor connected to the first node and to the third node;
a seventh transistor comprising a P-type transistor comprising a control electrode connected to a fourth node, a first electrode connected to a fifth node, and a second electrode connected to a sixth node;
an eighth transistor configured to apply a second data voltage to the seventh transistor;
a ninth transistor comprising a N-type transistor connected to the fourth node and to the sixth node;
a twelfth transistor comprising a N-type transistor configured to apply a first initialization voltage to the fourth node in response to a second initialization signal; and
a light-emitting element configured to emit light based on the data voltage and the second data voltage, and configured to sequentially emit light in a unit of a pixel row.

20. An electronic apparatus comprising:
a display panel comprising a pixel circuit;
a gate driver configured to output a gate signal to the pixel circuit;
a data driver configured to output a data voltage to the pixel circuit;
a driving controller configured to control the gate driver and the data driver; and
a processor configured to output input image data to the driving controller,
wherein the pixel circuit comprises:
a first transistor comprising a P-type transistor comprising a control electrode connected to a first node, a first electrode connected to a second node, and a second electrode connected to a third node;
a second transistor configured to apply the data voltage to the first transistor;
a third transistor comprising a N-type transistor connected to the first node and to the third node;
a seventh transistor comprising a P-type transistor comprising a control electrode connected to a fourth node, a first electrode connected to a fifth node, and a second electrode connected to a sixth node;
an eighth transistor configured to apply a second data voltage to the seventh transistor;
a ninth transistor comprising a N-type transistor connected to the fourth node and to the sixth node;
a twelfth transistor comprising a N-type transistor configured to apply a first initialization voltage to the fourth node in response to a second initialization signal; and
a light-emitting element configured to emit light based on the data voltage and the second data voltage, and configured to sequentially emit light in a unit of a pixel row.
